(19) United States
(12) Patent Application Publication
(10) Pub. No.: US 2005/0224348 A1
(43) Pub. Date: Oct. 13, 2005

(54) Structure of gas sensor ensuring gas/liquid tight sealing

(75) Inventors: Motoaki Satou, Anjo-shi (JP); Kiyomi Kobayashi, Kuwana-shi (JP); Yasufumi Suzuki, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/104,522

(22) Filed: Apr. 13, 2005

(30) Foreign Application Priority Data
Apr. 13, 2004 (JP) 2004-118161
Feb. 4, 2005 (JP) 2005-029640

(51) Int. Cl. G01N 27/26

(52) U.S. Cl. 204/424; 204/431

(57) ABSTRACT

An improved structure of a gas sensor is provided which is designed to establish a desired degree of gas/liquid tight sealing between a sensor element and a housing. The gas sensor includes a powder seal fitted in a chamber defined between the sensor element and the housing. The dimensions of the powder seal and the chamber are selected to enhance gas/liquid tight properties of the powder seal.

### CROSS REFERENCE TO RELATED DOCUMENT

The present application claims the benefit of Japanese Patent Application No. 2004-118161 filed on Apr. 13, 2004 and Japanese Paten Application No. 2005-029640 filed on Feb. 4, 2005, the disclosures of which are incorporated herein by reference.

### BACKGROUND OF THE INVENTION

1. Technical Field of the Invention

The present invention relates generally to a gas sensor which is installed, for example, in an exhaust system of automotive internal combustion engines to measure a given component of exhaust emissions for use in air-fuel ratio control of the engine, and more particularly to an improved structure of such a gas sensor which is designed to ensure a higher degree of gas/liquid-tight sealing.

2. Background Art

There are known gas sensors installed in an exhaust pipe of an automotive engine for use in air-fuel ratio control of the engine. One of such a type of gas sensors includes a housing, a sensor element retained within the housing, a gas-exposed cover joined to a base end of the housing to surround a top portion of the sensor element, and an air-exposed cover joined to a top end of the housing to surround a base portion of the sensor element.

The gas-exposed cover has defined therein a gas chamber which is to be filled with gas to be measured and to which the top portion of the sensor element is exposed. The air-exposed cover has defined therein an air chamber which is to be filled with surrounding air used as a reference gas. The gas sensor utilizes the gas and the air to measure the concentration of a given component of the gas. It is, thus, essential for ensuring the accuracy of such measurement to establish a gas-tight seal between the air chamber and the gas chamber.

Immediately after start-up of the engine, droplets of fuel may enter the gas chamber. It is, thus, also essential to establish a liquid-tight seal between the sensor element and the housing to avoid entrance of the droplets of fuel inside the gas sensor.

Japanese Patent First Publication No. 2001-281209 (U.S. Pat. No. 6,510,728 B2) teaches sealing between a sensor element and a housing of a gas sensor of the type, as described above, using a powder material or a powder block. Specifically, a seal is formed by filling a chamber between the sensor element and the housing with a powder material, placing a porcelain insulator on the powder material, and pressing the porcelain insulator to compress the powder material or alternatively by fitting a powder block contoured to the shape of the chamber within the chamber.

U.S. Pat. No. 5,846,391 also teaches a seal between a sensor element and a housing of a gas sensor.

The above type of gas sensors, however, have the problem in that the gas sensor is usually subjected to thermal shocks cyclically, thus resulting in a decrease in air/liquid tightness of the seal.

Keeping air/liquid tight requirements also after the gas sensor is subjected to the thermal shocks may be achieved by elevating the pressure acting on the porcelain insulator to compress the powder material to make the powder material more dense, but however, the sensor element is usually made of ceramic that is lower in mechanical strength and fragile, so that such an elevation in the pressure may result in breakage or cracks in the body of the sensor element.

There are also known gas sensors which has a sensing assembly installed in a housing which is made up of a sensor element and an annular porcelain insulator fitted around the sensor element. The annular porcelain insulator serves to protect the sensor element from physical impacts, so that the sensor element is less susceptive to the damage, but the annular porcelain insulator is also made of ceramic and susceptible to cracks.

### SUMMARY OF THE INVENTION

It is therefore a principal object of the invention to avoid the disadvantages of the prior art.

It is another object of the invention to provide an improved structure of a gas sensor which is designed to establish a higher degree of gas/liquid tight sealing without sacrificing mechanical strength thereof.

According to one aspect of the invention, there is provided an improved structure of a gas sensor working to measure a given component content in a gas. The gas sensor comprises: (a) a hollow cylindrical housing having a top end and a base end opposed to the top end, the housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of the housing; (b) a sensor element disposed in the housing, the sensor element having a length made up of a base portion and a top portion which is to be exposed to a gas to be sensed, the sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, the sensor element being disposed within the housing and supported at the top side tapered surface thereof on the tapered support surface of the housing; (c) an air cover joined to the base end of the housing to surround the base portion of the sensor element; (d) a gas cover joined to the top end of the housing to surround the top portion of the sensor element; (e) an annular chamber defined by the base side tapered surface and the sealing surface of the housing and the base side tapered surface and the sealing surface of the sensor element; (f) a powder seal with a top end and a base end, the powder seal being disposed at the top end thereof on the base side tapered surfaces of the housing and the sensor element within the annular chamber; and (g) a cylindrical insulating seal disposed on the base end of the powder seal.

If a radius of curvature of the corner of the bulging portion of the sensor element is defined as R1 mm, a radius of curvature of the corner of the housing is defined as R2 mm, a greater one of R1 mm and R2 mm is defined as Rmm, and a distance between the upright walls of the housing and the bulging portion of the sensor element in a transverse direction perpendicular to a length of the gas sensor is defined as L1 mm, they meet relations of R≦−0.5×L1+2.0, 0<L1≦0.25, 0<R1≦1.25, and 0<R2≦1.25. This ensures a higher degree of gas/liquid tight sealing between the sensor element and the housing without sacrificing mechanical strength of parts of the gas sensor.

The radius of curvatures R1 and R2 may alternatively have relations of 0.01≦R1≦1.25, and 0.01≦R2≦1.25, respectively.

The powder seal may have a bottom abutting the base side tapered surfaces of the sensor element and the housing. The bottom includes an inner tapered surface facing the base side tapered surface of the sensor element and an outer tapered surface facing the base side tapered surface of the housing. If an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they may meet relations of 0≦θ1≦50, 0≦θ2≦50, and 120≦θ3≦180 where θ1+θ2+θ3=180°.

In the above structure, if an angle which a line extending in a transverse direction perpendicular to a length of the gas sensor makes with a line extending along the base side tapered surface of the housing θ°, it may alternatively meet relations of R≦−0.075×θ+2.75, 0≦θ≦25, 0≦R1≦1.25, and 0<R2≦1.25.

Alternatively, if an intersection between lines extending along the base side tapered surface and the upright surface of the sensor element is defined as A, an intersection between lines extending along the base side tapered surface and the upright surface of the housing is defined as B, and a distance between the intersections A and B along a line extending in a lengthwise direction of the gas sensor is defined as [AB]mm, they may meet relations of [AB]≦−10×L1+2.5, 0<L1≦0.25, and 0≦[AB]≦1.5.

Alternatively, if a radius of curvature of a corner of the the insulating seal facing the powder seal and the sensor element is defined as R3 mm, a radius of curvature of a corner of the insulating seal facing the powder seal and the housing is defined as R4 mm, a greater one of R3 mm and R4 mm is defined as R'mm, a distance between an inside surface of the insulating seal and the sealing surface of the sensor element is defined as M1 mm, and a distance between an outside surface of the insulating seal and the sealing surface of the housing is defined as M2 mm, they may meet relations of R′≦−4×(M1+M2)/2+0.7 and (M1+M2)/2≧0.025.

Alternatively, if a sectional area of a clearance between the upright surfaces of the sensor element and the housing in the transverse direction of the gas sensor is defined as S1 mm², and a sectional area of the powder seal in the transverse direction of the gas sensor is defined as S2 mm², they may have relations of S1/S2×100≦10 and L1≦0.25.

According to another aspect of the invention, there is provided a gas sensor which comprises: (a) a hollow cylindrical housing having a top end and a base end opposed to the top end, the housing having formed on an inner wall thereof a tapered seat and a sealing surface extending from the tapered seat toward the base end of the housing; (b) a hollow cylindrical porcelain insulator holder having a base side end, a top side end, and an inner surface with a seat, the insulator holder being seated on the tapered seat of the housing; (c) a sensor element disposed in the housing, the sensor element having a length made up of a base portion and a top portion which is to be exposed to a gas to be sensed, the sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, and an upright surface between the top side and base side tapered surfaces, the sensor element being disposed within the housing and supported at the top side tapered surface thereof on the seat formed on the inner surface of the insulator holder; (d) an air cover joined to the base end of the housing to surround the base portion of the sensor element; (e) a gas cover joined to the top end of the housing to surround the top portion of the sensor element; (f) an annular chamber defined by the sealing surface and the base side tapered surface of the sensor element, the sealing surface of the housing, and the base end of the insulator holder; (g) a powder seal with a top end and a base end, the powder seal being disposed at the top end thereof on the base side tapered surface of the sensor element and the base end of the insulator holder within the annular chamber; and (h) a cylindrical insulating seal disposed on the base end of the powder seal.

If a sectional area of a clearance between the upright surface of the sensor element and the inner surface of the insulator holder in a transverse direction perpendicular to a length of the sensor element is defined as U1 mm², a sectional area of a clearance between the sealing surface of the housing and an outer surface of the insulator holder in the transverse direction is defined as U2 mm², and a sectional area of the powder seal in the transverse direction is defined as S2 mm², they have a relation of (U1+U2)/S2×100≦10.

According to a further aspect of the invention, there is provided a gas sensor which comprises: (a) a hollow cylindrical housing having a top end and a base end opposed to the top end, the housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of the housing; (b) a sensor element disposed in the housing, the sensor element having a length made up of a base portion and a top portion which is to be exposed to a gas to be sensed, the sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, the sensor element being disposed within the housing and supported at the top side tapered surface thereof on the tapered support surface of the housing; (c) an air cover joined to the base end of the housing to surround the base portion of the sensor element; (d) a gas cover joined to the top end of the housing to surround the top portion of the sensor element; (e) an annular chamber defined by the base side tapered surface and the sealing surface of the housing and the base side tapered surface and the sealing surface of the sensor element; (f) a powder seal with a top end and a base end, the powder seal being disposed at the top end thereof on the base side tapered surfaces of the housing and the sensor element within the annular chamber; and (g) a cylindrical insulating seal disposed on the base end of the powder seal.

If a sectional area of the powder seal in a transverse direction perpendicular to a length of the gas sensor is defined as S2 mm², a sectional area of a clearance between the sealing surface of the sensor element and an inner surface of the insulating seal in the transverse direction is defined as S3 mm², a sectional area of a clearance between the sealing surface of the housing and an outer surface of the insulating seal is defined as S4 mm², a distance between the inner surface of the insulating seal and the sealing surface of the sensor element is defined as M1 mm, and a distance between the outer surface of the insulating seal and the sealing surface of the housing is defined as M2 mm, they have relations of [(S3+S4)/S2]×100≦10, and (M1+M2)/2≧0.025.

According to a further aspect of the invention, there is provided a gas sensor which comprises: (a) a hollow cylindrical housing having a top end and a base end opposed to the top end, the housing having formed on an inner wall thereof a base side tapered surface, an upright surface, a tapered support surface, a corner, and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of the housing; (b) a sensing assembly disposed within the housing and having a top end and a base end, the sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, an upright surface between the top side and base side tapered surfaces, and a corner between the bas side tapered surface and the upright surface, the porcelain insulator being disposed within the housing and supported at the top side tapered surface thereof on the tapered support surface of the housing; (c) an air cover joined to the base end of the housing to surround the base portion of the sensor element; (d) a gas cover joined to the top end of the housing to surround the top portion of the sensor element; (e) an annular chamber defined by the sealing surface and the base side tapered surface of the porcelain insulator of the sensing assembly and the sealing surface and the base side tapered surface of the housing; (f) a powder seal with a top end and a base end, the powder seal being disposed at the top end thereof on the base side tapered surfaces of the porcelain insulator of the sensing assembly and the housing within the annular chamber; and (g) a cylindrical insulating seal disposed on the base end of the powder seal.

If radiuses of curvature of the corners of the porcelain insulator of the sensing assembly and the housing are defined as Q1 mm and Q2 mm, respectively, a greater one of Q1 mm and Q2 mm is defined as Qmm, and a distance between the upright surfaces of the housing and the porcelain insulator of the sensing assembly in a transverse direction perpendicular to a length of the gas sensor is defined as K1, they have relations of Q≦−0.5×K1+2.0, 0<K1≦0.25, 0<Q1≦1.25, and 0<Q2≦1.25.

Alternatively, if an angle which a line extending perpendicular to a length of the gas sensor makes with a line extending along the base side tapered surface of the housing is defined as φ°, it may meet relations of relations of Q≦−0.075×φ+2.75, 0<φ≦25, 0<Q1≦1.25, and 0<Q2≦1.25.

Alternatively, if a distance between the upright surfaces of the sensing assembly and the housing in a transverse direction perpendicular to a length of the gas sensor is defined as K1 mm, an intersection between a line extending along the base side tapered surface of the sensing assembly and a line extending along the upright surface of the sensing assembly is defined as C, an intersection between a line extending along the base side tapered surface of the housing and a line extending along the upright surface of the housing is defined as D, and a distance between the intersections C and D along a line extending in a lengthwise direction of the gas sensor is defined as [CD]mm, they may meet relations of [CD]≦−10×K1+2.5, 0<K1≦0.25, and 0≦[CD]≦1.5.

Alternatively, if a radius of curvature of a corner of the cylindrical insulating seal closer to the powder seal and the sensing assembly is defined as Q3 mm, a radius of curvature of a corner of the cylindrical insulating seal closer to the powder seal and the housing is defined as Q4 mm, a greater one of Q3 mm and Q4 mm is defined as Q′mm, a distance between an inner surface of the insulating seal and the sealing surface of the sensing assembly is defined as N1 mm, and a distance between an outer surface of the insulating seal and the sealing surface of the housing is defined as N2 mm, they may have relations of Q′≦−4×(N1+N2)/2+0.7, and (N1+N2)/2≧0.025.

Alternatively, a sectional area of a clearance between the upright surfaces of the sensing assembly and the housing which extends in the transverse direction is defined as T1 mm², and a sectional area of the powder seal extending in the transverse direction is defined as T2 mm², they may have relations of T1/T2×100≦10, and K1≦0.25.

According to a further aspect of the invention, there is provided a gas sensor which comprises: (a) a hollow cylindrical housing having a top end and a base end opposed to the top end, the housing having formed on an inner wall thereof a tapered seat and a sealing surface extending from the tapered seat toward the base end of the housing; (b) a hollow cylindrical porcelain insulator holder having a base side end, a top side end, and an inner surface with a seat, the insulator holder being seated on the tapered seat of the housing; (c) a sensing assembly disposed within the housing and having a top end and a base end, the sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward a top end of the top portion, a base side tapered surface oriented toward the base end of the base portion, and an upright surface between the top side and base side tapered surfaces, the porcelain insulator being disposed within the housing and supported at the top side tapered surface thereof on the seat formed on the inner surface of the insulator holder; (d) an air cover joined to the base end of the housing to surround the base portion of the sensor element; (e) a gas cover joined to the top end of the housing to surround the top portion of the sensor element; (f) an annular chamber defined by the sealing surface and the base side tapered surface of the sensing assembly, the sealing surface of the housing, and the base end of the insulator holder; (g) a powder seal with a top end and a base end, the powder seal being disposed at the top end thereof on the base side tapered surface of the sensing assembly and the base end of the insulator holder within the annular chamber; and (h) a cylindrical insulating seal disposed on the base end of the powder seal.

If a transverse sectional area of a clearance between the upright surface of the sensing assembly and an inner surface of the insulator holder which extends in a transverse direction perpendicular to a length of the gas sensor is defined as V1 mm², a transverse sectional area of a clearance between the sealing surface of the housing and an outer surface of the insulator holder which extends in the transverse direction is defined as V2 mm², and a transverse sectional area of the powder seal extending in the transverse direction is defined as T2 mm², they may have a relation of (V1+V2)/T2×100≦10.

According to a further aspect of the invention, there is provided a gas sensor which comprises: (a) a hollow cylindrical housing having a top end and a base end opposed to the top end, the housing having formed on an inner wall thereof a base side tapered surface, an upright surface, a tapered support surface, and a sealing surface, the upright surface extending from the base side tapered surface toward the top end, the tapered support surface extending from the upright surface more inwardly than the base side tapered surface toward the top end thereof, the sealing surface extending from the base side tapered surface toward the base end of the housing; (b) a sensing assembly disposed within the housing and having a top end and a base end, the sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, and an upright surface between the top side and base side tapered surfaces, the porcelain insulator being disposed within the housing and supported at the top side tapered surface thereof on the tapered support surface of the housing; (c) an air cover joined to the base end of the housing to surround the base portion of the sensor element; (d) a gas cover joined to the top end of the housing to surround the top portion of the sensor element; (e) an annular chamber defined by the sealing surface and the base side tapered surface of the porcelain insulator of the sensing assembly and the sealing surface and the base side tapered surface of the housing; (f) a powder seal with a top end and a base end, the powder seal being disposed at the top end thereof on the base side tapered surfaces of the porcelain insulator of the sensing assembly and the housing within the annular chamber; and (g) a cylindrical insulating seal disposed on the base end of the powder seal.

If a transverse sectional area of the powder seal extending in a transverse direction perpendicular to a length of the gas sensor is defined as T2 mm², a transverse sectional area of a clearance between the sealing surface of the sensing assembly and an inside surface of the insulating seal which extends in the transverse direction is defined as T3 mm², a transverse sectional area of a clearance between the sealing surface of the housing and an outside surface of the insulating seal is defined as T4 mm², a distance between the inside surface of the insulating seal and the sealing surface of the sensing assembly is defined as N1 mm, and a distance between the outside surface of the insulating seal and the sealing surface of the housing is defined as N2 mm, they have relations of [(T3+T4)/T2]×100≦10, and (N1+N2)/2≧0.025.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a structure of a gas sensor according to the first embodiment of the invention;

FIG. 2 is a partially enlarged view which shows a sealing structure of the gas sensor of FIG. 1;

FIG. 3 is a partially enlarged view which shows a powder seal forming a gas/liquid tight seal in the gas sensor of FIG. 1;

FIGS. 4(a), 4(b), and 4(c) are longitudinal sectional views which show a sequence of liquid leakage test operations on samples of the gas sensor of FIG. 1;

FIGS. 5(a), 5(b), and 5(c) are longitudinal sectional views which show results of tests, as illustrated in FIGS. 4(a), 4(b), and 4(c);

FIG. 6 is a sectional view which shows an air leakage test device;

FIG. 7 is a diagram in which test samples are plotted after being subjected to air and liquid leakage tests;

FIG. 8 is a partially enlarged view which shows a sealing structure of a gas sensor according to the second embodiment of the invention;

FIG. 9 is a partially enlarged view which shows profiles of a sensor element and a housing which defines an annular sealing chamber of the gas sensor of FIG. 8;

FIG. 10 is a diagram in which test samples are plotted after being subjected to air and liquid leakage tests in the second embodiment;

FIG. 11 is a partially enlarged view which shows a sealing structure of a gas sensor according to the third embodiment of the invention;

FIG. 12 is a partially enlarged view which shows profiles of a sensor element and a housing which defines an annular sealing chamber of the gas sensor of FIG. 11;

FIG. 13 is a diagram in which test samples are plotted after being subjected to air and liquid leakage tests in the third embodiment;

FIG. 14 is a partially enlarged view which shows a sealing structure of a gas sensor according to the fourth embodiment of the invention;

FIG. 15 is a diagram in which test samples are plotted after being subjected to air and liquid leakage tests in the fourth embodiment;

FIG. 16 is a partially enlarged view which shows a sealing structure of a gas sensor according to the fifth embodiment of the invention;

FIG. 17 is a sectional view, as taken along the line A-A in FIG. 16;

FIG. 18 is a sectional view, as taken along the line B-B in FIG. 16;

FIG. 19 is a diagram in which test samples are plotted after being subjected to air and liquid leakage tests in the fifth embodiment;

FIG. 20 is a partially enlarged sectional view which shows a gas sensor according to the sixth embodiment of the invention;

FIG. 21 is a partially longitudinal sectional view which shows a sealing structure of the gas sensor of FIG. 20;

FIG. 22 is a sectional view, as taken along the line C-C in FIG. 21;

FIG. 23 is a sectional view, as taken along the line D-D in FIG. 21;

FIG. 24 is a partially longitudinal sectional view which shows a sealing structure of a gas sensor according to the seventh embodiment of the invention;

FIG. 25 is a sectional view, as taken along the line E-E in FIG. 24;

FIG. 26 is a longitudinal sectional view which shows a structure of a gas sensor according to the eighth embodiment of the invention;

FIG. 27 is a partially enlarged view which shows a sealing structure of the gas sensor of FIG. 26; and

FIG. 28 is a longitudinal sectional view which shows a modified form of a powder seal.

### DESCRIPTION OF THE PREFERRED EMBODIMENTS

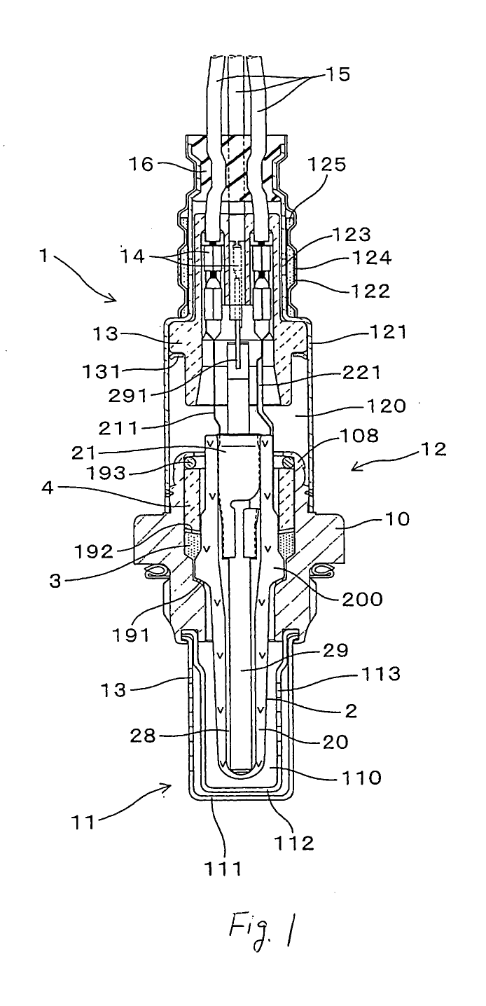

Referring to the drawings, wherein like reference numbers refer to like parts in several views, particularly to FIG. 1, there is shown a gas sensor 1 according to the first embodiment of the invention which may be installed in an exhaust system of an automotive internal combustion engine to measure the concentration of a given component such as O₂, NOx, CO, or HC contained in exhaust emissions for burning control of the engine. For example, the gas sensor 1 may be implemented by as an oxygen (O₂) sensor or an air-fuel ratio sensor.

The gas sensor 1 includes a hollow cylindrical housing 10, a sensor element 2 disposed within the housing 10, a protective cover assembly 11 joined to a top end (i.e., a lower end, as viewed in the drawing) of the housing 10 to surround a top portion (i.e., a sensing portion) of the sensor element 2, and an air cover assembly 12 joined to a base end (i.e., an upper end, as viewed in the drawing) of the housing 10 to surround a base portion of the sensor element 10.

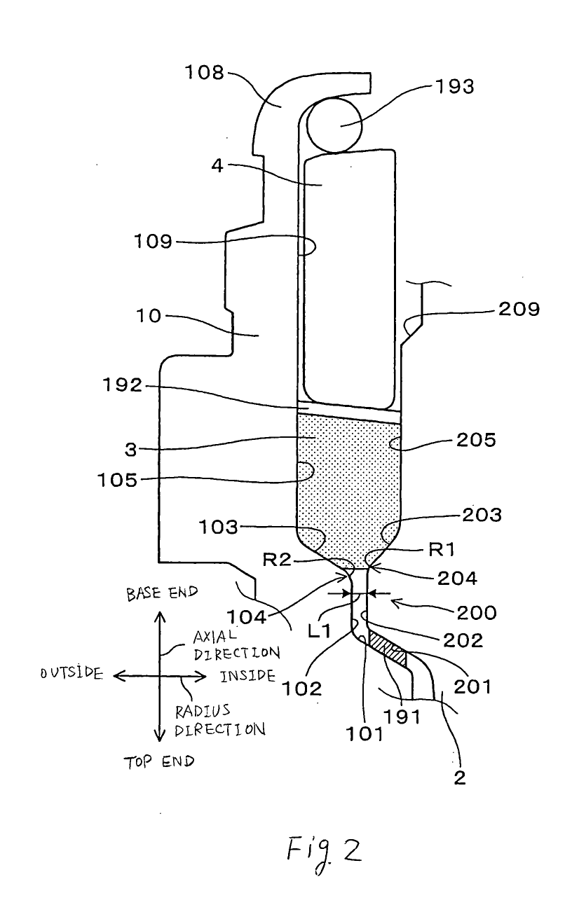

The sensor element 2 has, as clearly shown in FIG. 2, an outer wall 209 on which an annular flange 200 is formed which bulges outward in a radius direction of the sensor element 2. The outer wall 209 also has a sealing surface 205 extending from the flange 200 to the base end of the sensor element 2. The flange 200 has a top side tapered wall 201 facing the top end of the sensor element 2, a base side tapered wall 203 facing the base end of the sensor element 2, and an upright wall 202 extending between the top and base side tapered walls 201 and 203. Between the upright wall 202 and the base side tapered wall 203, a corner 204 is formed which is rounded with a radius of curvature R1 mm.

The housing 10 has an inner wall 109 on which a tapered support wall 101, an upright wall 102, a base side tapered wall 103, and a sealing wall 105 are formed. The support wall 101 bulges inward of the housing 10 to form a seat for bearing the top side tapered wall 201 of the sensor element 2. The upright wall 102 extends between the support wall 101 and the base side tapered wall 103. The base side tapered wall 103 is oriented to face the base end of the housing 10. The sealing wall 105 extends from the base side tapered wall 103 to the base end of the housing 10. Formed between the upright wall 102 and the base side tapered wall 103 is a corner 104 rounded with a radius of curvature R2 mm.

A powder seal 3 is disposed within a cylindrical chamber defined by the sealing wall 205 and the base side tapered wall 203 of the sensor element 2, and the sealing wall 105 and the base side tapered wall 103 of the housing 10. A cylindrical insulating seal 4 is also disposed within the chamber in contact with the powder seal 3.

If an interval or distance between the upright wall 202 of the sensor element 2 and the upright wall 102 of the housing 10 in a radius direction of the gas sensor 1 (i.e., a direction perpendicular to a longitudinal center line of the gas sensor 1) is defined as L1 mm, and a greater one of R1 mm and R2 mm is defined as Rmm, they are selected to have relations of R≦−0.5×L1+2.0, 0<L1≦0.25, 0<R1≦1.25, and 0<R2≦1.25.

The protective cover assembly 11 is, as described above in FIG. 1, affixed to the top end of the housing 10. The air cover assembly 12 is welded to the base end of the housing 10. The protective cover assembly 11 has a double-walled structure made up of an outer cover 111 and an inner cover 112. The inner cover 112 has defined therein a gas chamber 110 within which the sensing portion of the sensor element 2 is exposed to gas such as exhaust gas of the engine to be measured. The air cover assembly 12 is made up of a main cover 121 and an outer cover 122. The outer cover 122 is affixed to a small-diameter portion of the main cover 121. Such affixing is achieved by crimping the outer cover 122, thereby also retaining a water-repellent filter 125 between the outer cover 122 and the main cover 121.

The main cover 121 has defined therein an air chamber 120 to which the base portion of the sensor element 2 is exposed. The air chamber 120 communicates with an air chamber 28 formed in the sensor element 2. The main cover 121 and the outer cover 122 have formed therein air vents 123 and 124 through which surrounding air is admitted into the air chamber 120 as a reference gas.

Within the main cover 121, a porcelain insulator 13 is retained by a disc spring 131. Within the porcelain insulator 13, terminal connectors 14 are disposed which joint sensor output conductors 211 and 221 to leads 15 and heater conductors 291 with leads 15.

A rubber bush 16 working as an elastic insulator is retained above the porcelain insulator 13 within an open end of the air cover assembly 12. The rubber bush 16 has the leads 15 retained therein.

The sensor element 2 is made up of a bottomed cup-shaped solid electrolyte body 20, a pair of electrodes (not shown) affixed to a surface of the solid electrolyte body 20, and a bar-shaped heater 29. The solid electrolyte body 20 has formed therein the air chamber 28 to be filled with air used as a reference gas. The sensor output conductors 211 and 221 are joined to the base end of the sensor element 2 in electrical connection with the electrodes. The heater conductors 291 are joined to the base end of the heater 29 in electrical connection with a heating element (not shown) disposed inside the heater 29.

The solid electrolyte body 20 of the sensor element 2 has the outer wall 209 on which the flange 200 is formed and the sealing wall 205 closer to the base end of the solid electrolyte body 20 than the flange 200.

The flange 200, as described above, includes the base side tapered wall 203, the top side tapered wall 201, and the upright wall 202 extending between the tapered walls 203 and 201. The corner 204 is formed between the upright wall 202 and the base side tapered wall 203 and rounded with the radius of curvature R1 mm.

The inner wall 109 of the housing 10 includes the support wall 101, the upright wall 102, the bas side tapered wall 103, and the sealing wall 105. The corner 104 is formed between the upright wall 102 and the base side tapered wall 103 and rounded with the radius of curvature R2 mm.

The flange 200 of the sensor element 2 is seated on the support wall 101 through a gasket 191.

The powder seal 3 is, as described above, disposed within the cylindrical chamber defined by the sealing wall 205, the base side tapered wall 203, the sealing wall 105, and the base side tapered wall 103. The cylindrical insulating seal 4 is also disposed within the chamber in abutment with the powder seal 3 through the gasket 192.

The insulating seal 4 is urged elastically in a downward direction, as viewed in FIG. 2, by a crimped end 108 of the housing 10 through a ring 193. Specifically, the pressure, as produced by bending or crimping the end 108 of the housing 10 inwardly, constantly acts on the insulating seal 4 and the gasket 192 to compress the powder seal 3. The powder seal 3 is made of talc powder that is one of clay minerals and a natural material containing a main component of Mg₃Si₄O₁₀(OH)₂. The powder seal 3 also contains sodium primary phoshate.

The distance between the upright wall 202 of the sensor element 2 and the upright wall 102 of the housing 10 in the radius direction of the gas sensor 1 is, as described above, L1 mm. Specifically, the distance along a line extending in the radius direction of the gas sensor 1 through one of boundaries between the corner 104 and the upright wall 102 and between the corner 204 and the upright wall 202 which is closer to the top end of the gas sensor 1 (i.e., the lower end, as viewed in FIGS. 1 and 2) is defined herein as L1 mm.

The corners 104 and 204 have curved surfaces whose radiuses of curvature are, as described above, R2 mm and R1 mm. A greater one of R1 and R2 is defined herein as Rmm. Note that the radius of curvature R1 may be equal to R2.

In the gas sensor 1 of this embodiment, R1=0.5 mm, R2=0.4 mm, L1=0.2 mm. The radiuses of curvatures R, R1, and R2 and the distance L1 are selected to meet relations of R≦−0.5×L1+2.0, 0<L1≦0.25, 0<R1≦1.25, and 0<R2≦1.25 (preferably, 0.01<R1≦1.25 and 0.01<R2≦1.25). If R1<0.01 mm, it may result in cracks in the flange 200 of the sensor element 2 arising from physical impact produced when the sensor element 2 is installed in the housing 10, which will result in decreased sealing between the sensor element 2 and the housing 10. If R2<0.01, it may result in increased susceptibility of electrodes or a protective layer formed on the body of the sensor element 2 or the flange 200 to cracks even when the sensor element 2 slightly abuts the corner 104 of the housing 10.

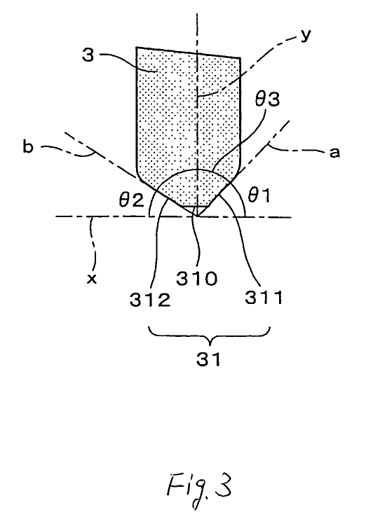

The powder seal 3, as clearly shown in FIG. 3, has a bottom surface 31 which is made up of an inner tapered surface 311, an outer tapered surface 312, and a flat surface 310 between the tapered surfaces 311 and 312. The surfaces 311 and 312 both taper toward the top end of the gas sensor 1. The flat surface 310 extends substantially perpendicular to the longitudinal center line of the gas sensor 1 (i.e., the axial direction).

If an angle which the inner tapered surface 311 makes with a line x extending perpendicular to the longitudinal center line of the gas sensor 1 is defined as θ1°, an angle which the outer tapered surface 312 makes with the line x is defined as θ2°, and an angle which the inner tapered surface 311 makes with the outer tapered surface 312 is defined as θ3° (θ1+θ2+θ3=180°), they are selected to have relations of 0°≦θ1≦50°, 0°≦θ2≦50°, and 120°≦θ3≦180°. For instance, θ1=30°, θ2=15°, θ3=135°. If θ1>50° and/or θ2>50°, it results in lack of transmission of compressive pressure to the bottom of the powder seal 3, so that the density of a lower portion of the powder seal 3 is not increased up to a desired level. This results in lack of gas/liquid tightness of the powder seal 3. Additionally, use of the gas sensor 1 for a long time may cause particles to be removed from the powder seal 3 due to cyclic thermal shocks, thus resulting in decrease in the air/liquid tightness of the powder seal 3.

The annular chamber within which the powder seal 3 is disposed is defined geometrically by the relations of R≦−0.5×L1+2.0, 0<L1≦0.25, 0<R1≦1.25, and 0<R2≦1.25. This serves to ensure air/liquid-tight properties, as exhibited by the powder seal 3, required to minimize entrance of gas or liquid inside the gas sensor 1 from the top end thereof. This permits the powder seal 3 to be compressed by a lowered pressure, thereby minimizing local defects, breakage, or cracks in the sensor element 2.

The bottom surface 31 of the powder seal 3, as described above, includes the inner and outer tapered surfaces 311 and 312 which are so geometrically defined as to meet the relations of 0°≦θ1≦50°, θ0≦θ2≦50°, and 120°≦θ3≦180°. This also enhances the air/liquid-tight properties of the powder seal 3.

We performed liquid leakage tests on samples of the gas sensor 1, as illustrated in FIG. 1, to evaluate the liquid tightness of the powder seal 3, as discussed below.

First, each test sample was heated from the top end thereof until the temperature of the inner and outer tapered surfaces 311 and 312 of the bottom surface 31 reached 400° C. Next, water was sprayed onto the base end of the sample. After the test sample was subjected to 1000 cycles of such a thermal shock, the sealing ability thereof was evaluated in the following manners.

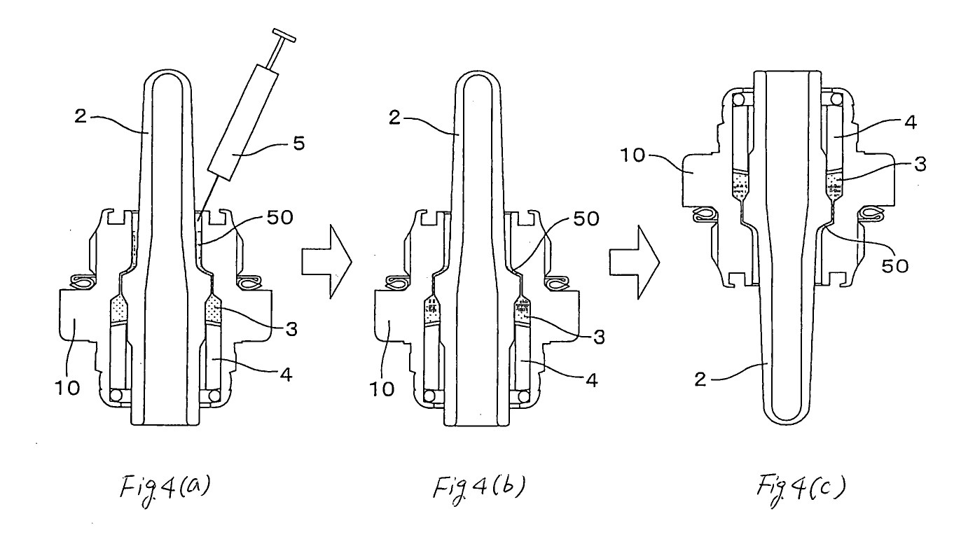

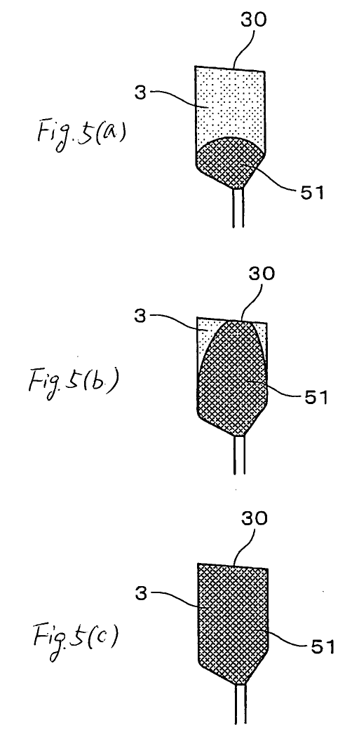

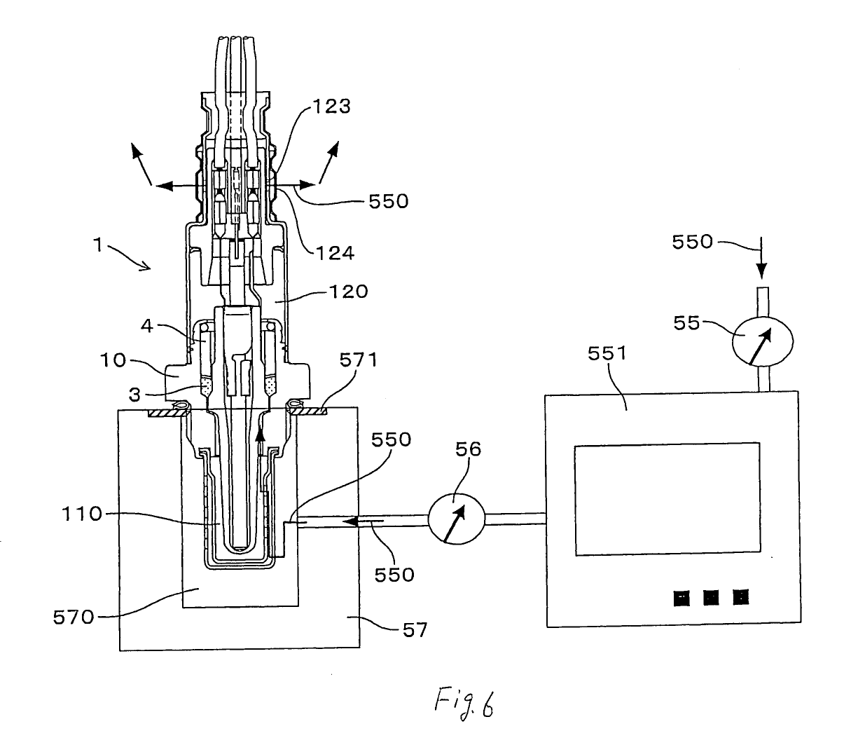

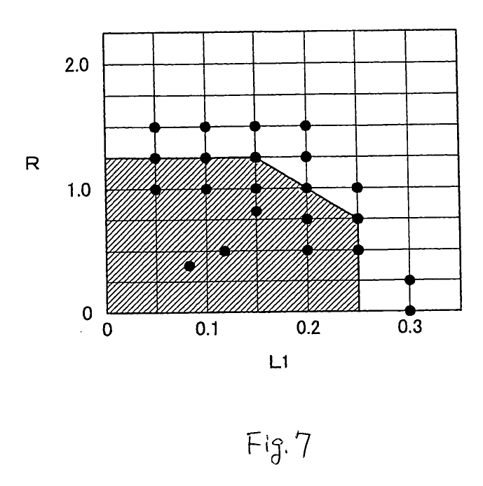

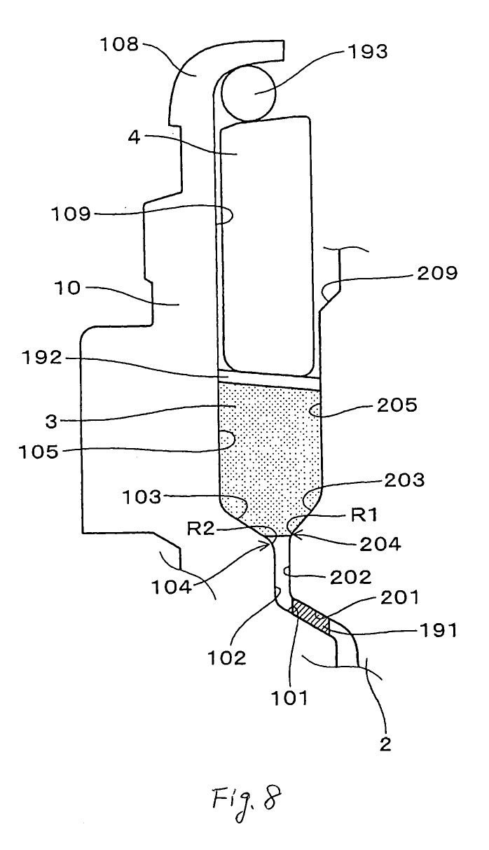

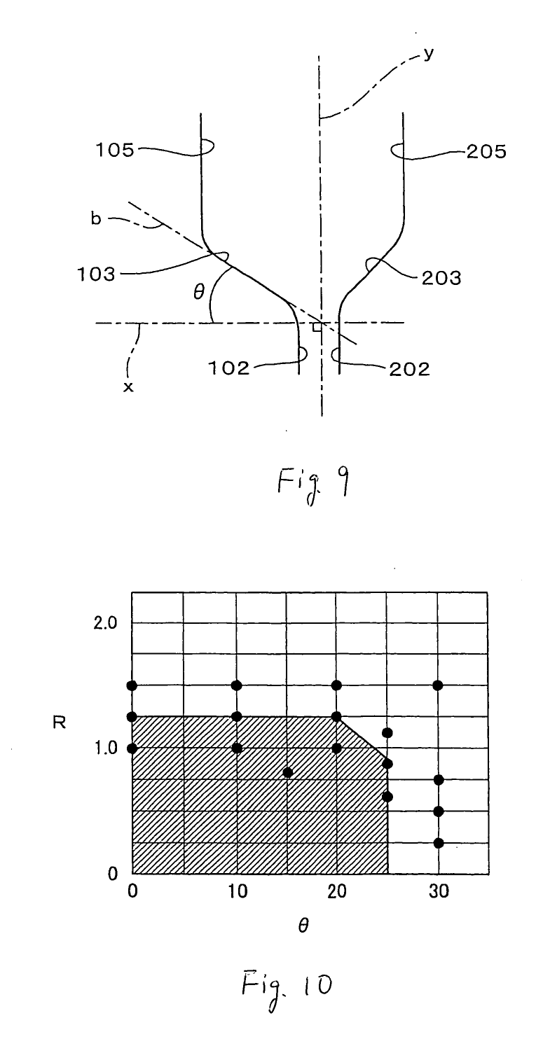

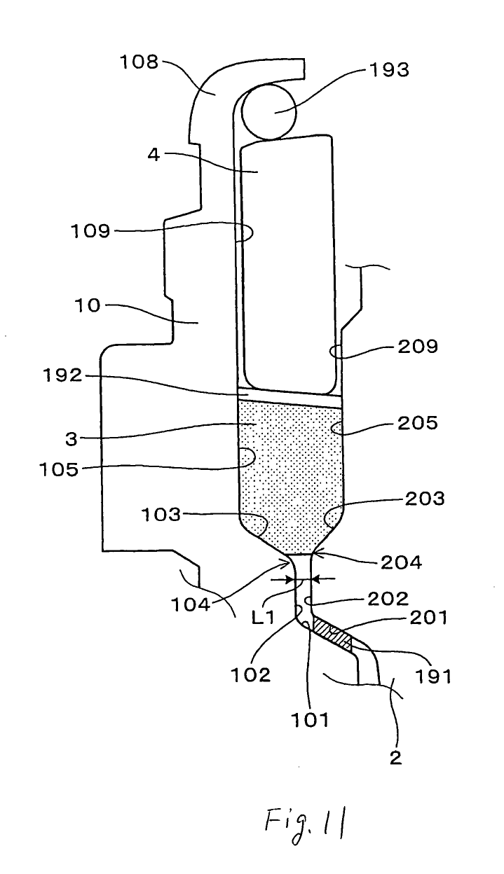

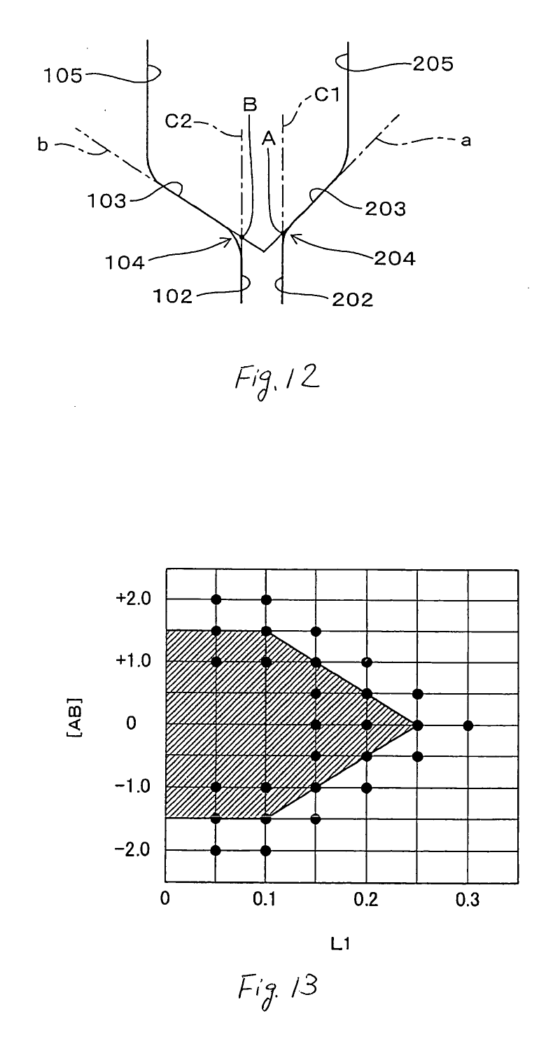

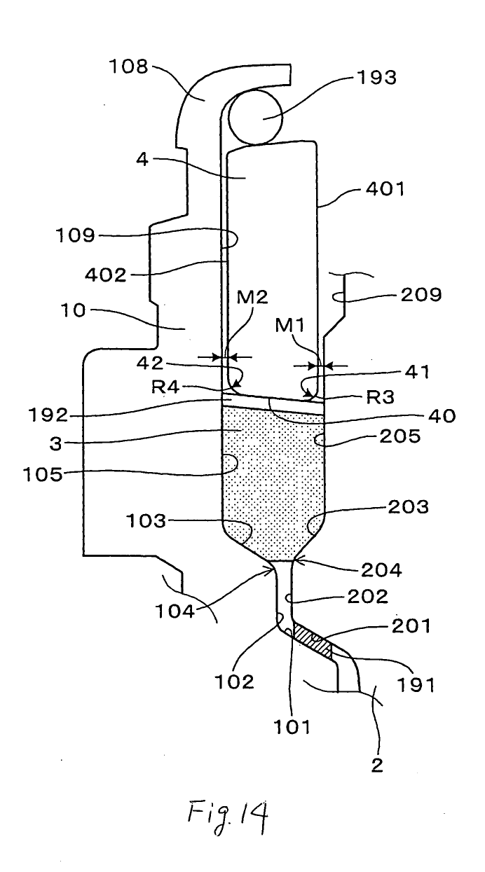

First, the protective cover assembly 11 and the air cover assembly 12 were, as illustrated in FIGS. 4(a) to 4(c), removed from each sample.

A staining liquid 50 was, as clearly shown in FIG. 4(a), injected using a syringe 5 into the powder seal 3 through between the sensor element 2 and the housing 10 from the top end (i.e., an upper end, as viewed in FIG. 4(a)) of the sample. The sample was left as it was for 12 hours.

Subsequently, a portion of the staining liquid 50 having not sunk into the powder seal 3 was, as shown in FIG. 4(b), withdrawn outside the sample. The sample was dried at 150° C. for two hours.

The sample was, as shown in FIG. 4(c), disassembled to take out the powder seal 3 for inspecting how much depth of the powder seal 3 the staining liquid 50 has reached.

FIGS. 5(a), 5(b), and 5(c) are cross sectional views which demonstrate how much depth of the powder seal 3 the staining liquid 50 has sunk to. We evaluate herein the samples in which a colored volume 51 of the powder seal 3 through which the staining liquid 50 has penetrated, as illustrated in FIG. 5(a), has not reached the end 30 as being excellent at the liquid tightness. The samples in which the colored volume 51, as shown in FIG. 5(b), has reached the end 30 or, as shown in FIG. 5(c), occupies the whole of the powder seal 3 will have the problem that if they are installed in an exhaust pipe of an internal combustion engine, it may cause droplets of fuel contained in exhaust gasses emitted immediately after start-up of the engine or condensed water staying in the exhaust pipe when the engine is at rest to enter inside the sample through the powder seal 3. We, therefore, evaluate those samples as being defective in the liquid tightness. Some specific results of the tests will be demonstrated later.

We also performed gas leakage tests on samples of the gas sensor 1 to evaluate the air tightness of the powder seal 3 using a test device, as illustrated in FIG. 6.

The test device includes a leakage measuring unit 551 equipped with an air regulator valve 55 and a gas sensor mount base 57. The leakage measuring unit 551 and the gas sensor mount base 57 are connected through a valve 56. The head of each of the test samples is installed in an air cavity 570 of the gas sensor mount base 57 hermetically through a rubber seal 571.

10 minutes after the air 550 was supplied to the air cavity 570 at 4 atm., a drop in pressure in the air cavity 570 was measured to determine the amount of air 550 (cc/min) leaking from the air cavity 570 to the air chamber 120. Specifically, if the air tightness of the powder seal 3 and the insulating seal 4 is insufficient to block the entrance of the air 550 into the air chamber 120, it will cause the air 550, as indicated by arrows in the drawing, to leak from the air vents 123 and 124 of the air cover assembly 12, thus resulting in a drop in pressure in the air cavity 570. We evaluate herein the samples in which the amount of air leakage is less than 0.5 cm³/min as being excellent at the air tightness and the others as being defective in the air tightness. It is advisable to check that no air is leaking from a portion other than the air vents 123 and 124 of test samples to be used in the above leakage test. Some specific results of the tests will be demonstrated below.

We prepared test samples of the gas sensor 1 having different values of R1, R2, and L1 and performed the above described liquid and air leakage tests on them.

FIG. 7 is a diagram in which the test samples are plotted. The abscissa axis indicates the distance L1. The ordinate axis indicates the radius of curvature R that is a greater one of R1 and R2. We analyzed the air- and liquid-tight properties of the samples and evaluated some of the samples within a hatched area as being excellent both in the air tightness and in the liquid tightness of the powder seal 3 and the others as being defective.

From the above test results, it is found that the gas sensor 1 in which the distance L1 between the upright wall 202 of the sensor element 2 and the upright wall 102 of the housing 10 in the radius direction of the gas sensor 1, the radius of curvature R1 of the corner 204, the radius of curvature R2 of the corner 104, and the radius of curvature R that is a greater one of R1 and R2 have the relations of R≦−0.5×L1+2.0, 0<L1≦0.25, 0<R1≦1.25, and 0<R2≦1.25 is excellent in the air and liquid-tight properties.

FIGS. 8 and 9 are partially sectional views which show a gas sensor according to the second embodiment of the invention.

If an angle which the line x extending perpendicular to the axial direction y of the gas sensor 1 makes with the line b extending along the surface of the base side tapered wall 103 of the housing 10 is defined as θ°, the radius of curvature of the corner 204 between the upright wall 202 and the base side tapered wall 203 of the sensor element 2 is defined as R1 mm, the radius of curvature of the corner 104 between the upright wall 102 and the base side tapered wall 103 of the housing 10 is defined as R2 mm, and a greater one of R1 and R2 is defined as Rmm, they are selected to meet relations of R≦−0.075×θ+2.75, 0≦θ≦25, 0<R1≦1.25, and 0<R2≦1.25. For instance, R1=0.2, R2=0.8, and θ=15°.

Other arrangements are identical with those in the first embodiment, and explanation thereof in detail will be omitted here.

We prepared test samples of the gas sensor of the second embodiment having different values of R1, R2, and θ and performed the above described liquid and air leakage tests on them.

FIG. 10 is a diagram in which the test samples are plotted. The abscissa axis indicates the angle θ. The ordinate axis indicates the radius of curvature R that is a greater one of R1 and R2. We analyzed the air- and liquid-tight properties of the samples and evaluated some of the samples within a hatched area as being excellent both in the air tightness and in the liquid tightness of the powder seal 3 and the others as being defective.

From the above test results, it is found that the gas sensor in which the angle θ which the line x extending perpendicular to the axial direction y of the gas sensor 1 makes with the line b extending along the surface of the base side tapered wall 103 of the housing 10, the radius of curvature R1 of the corner 204, the radius of curvature R2 of the corner 104, and the radius of curvature R that is a greater one of R1 and R2 have the relations of R≦−0.075×θ+2.75, 0≦θ≦25, 0<R1≦1.25, and 0<R2≦1.25 is excellent in the air and liquid-tight properties.

FIGS. 11 and 12 are partially sectional views which show a gas sensor according to the third embodiment of the invention.

If a distance between the upright wall 202 of the sensor element 2 and the upright wall 102 of the housing 10 in the radius direction of the gas sensor 1 is defined as L1 mm, an intersection between the line a extending along the surface of the base side tapered wall 203 and the line C1 extending along the surface of the upright wall 202 of the sensor element 2 is defined as A, an intersection between the line b extending along the surface of the base side tapered wall 103 and the line C2 extending along the surface of the upright wall 102 of the housing 10 is defined as B, and a minimum distance between the intersections A and B along a line extending in the axial direction (i.e., lengthwise direction) of the gas sensor 1 is defined as [AB]mm, they are selected to meet relations of [AB]≦−10×L1+2.5, 0<L1≦0.25, and 0≦[AB]≦1.5. For instance, [AB]=0.5, and L1=0.15.

Other arrangements are identical with those in the first embodiment, and explanation thereof in detail will be omitted here.

We prepared test samples of the gas sensor of the second embodiment having different values of [AB] and L1 and performed the above described liquid and air leakage tests on them.

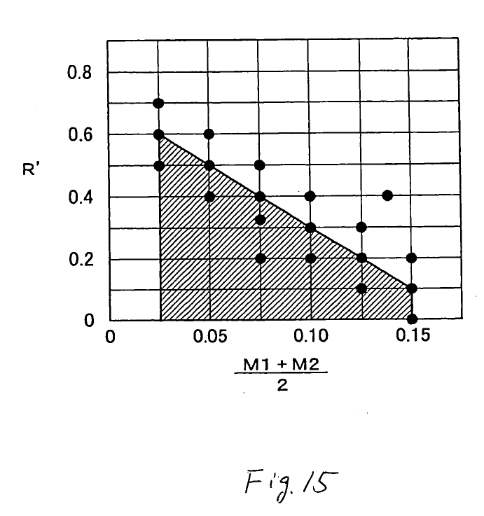

FIG. 13 is a diagram in which the test samples are plotted. The abscissa axis indicates the angle L1. The ordinate axis indicates [AB]. We analyzed the air- and liquid-tight properties of the samples and evaluated some of the samples within a hatched area as being excellent both in the air tightness and in the liquid tightness of the powder seal 3 and the others as being defective.

From the above test results, it is found that the gas sensor in which the distance L1 between the upright wall 202 of the sensor element 2 and the upright wall 102 of the housing 10 in the radius direction of the gas sensor 1, and the minimum distance between the intersections A and B along a line extending in the axial direction (i.e., lengthwise direction) of the gas sensor 1 meet the relations of [AB]≦−10×L1+2.5, 0<L1≦0.25, and 0≦[AB]≦1.5 is excellent in the air and liquid-tight properties.

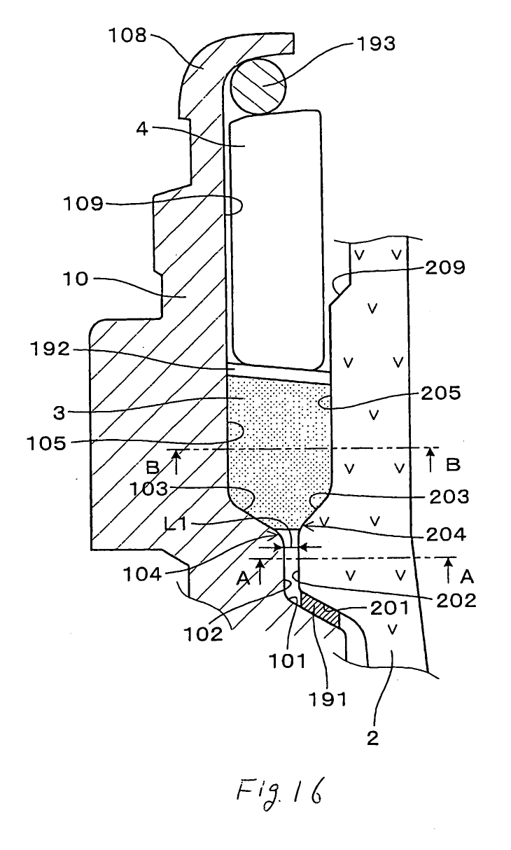

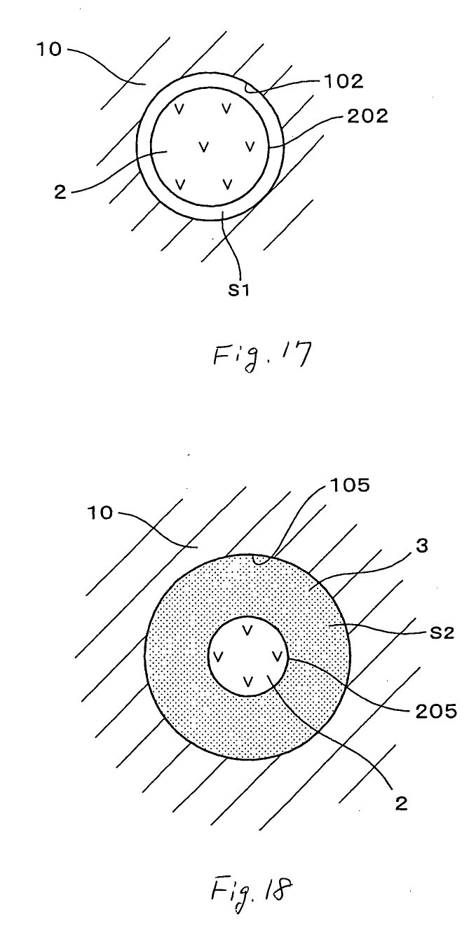

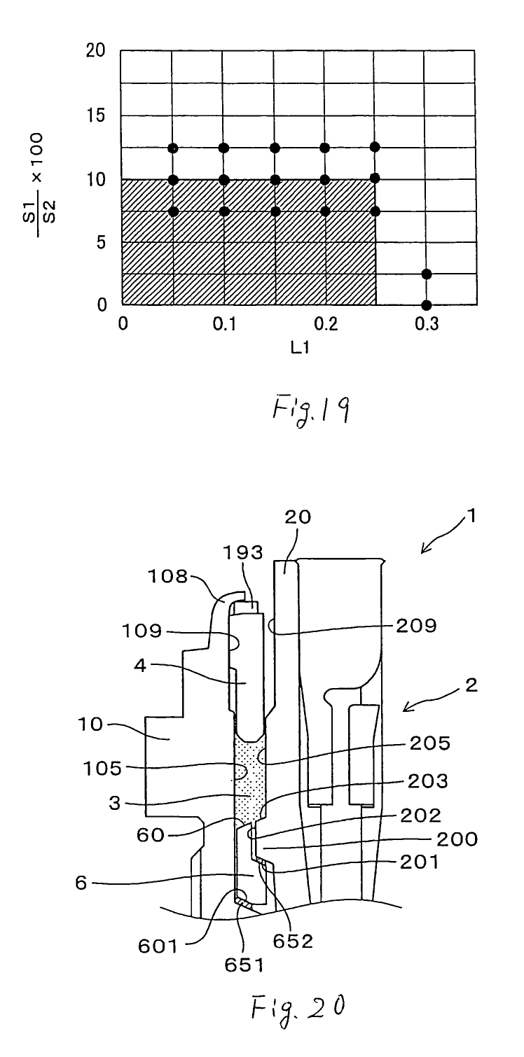

FIG. 14 is a partially sectional view which shows a gas sensor according to the fourth embodiment of the invention.

If a radius of curvature of the corner 41 of the cylindrical insulating seal 4 facing the powder seal 3 and the sensor element 2 is defined as R3 mm, a radius of curvature of the corner 42 of the cylindrical insulating seal 4 facing the powder seal 3 and the housing 10 is defined as R4 mm, a greater one of R3 and R4 is defined as R′ mm, a minimum distance between the inside surface 401 of the insulating seal 4 and the sealing wall 205 of the sensor element 2 is defined as M1 mm, and a minimum distance between the outside surface 402 of the insulating seal 4 and the inner wall 109 of the housing 10 is defined as M2 mm, they meet relations of R′≦−4×(M1+M2)/2+0.7, and (M1+M2)/2≧0.025. For instance, R3=0.2, R4=0.1, M1=0.10, and M2=0.15.

Other arrangements are identical with those in the first embodiment, and explanation thereof in detail will be omitted here.

We prepared test samples of the gas sensor of the second embodiment having different values of R3, R4, M1, and M2 and performed the liquid and air leakage tests, as discussed in FIGS. 4(a) to 6, on them. Note that in the liquid and air leakage tests of this embodiment, the staining liquid 50 and the air 500 were injected into the samples from the insulating seal 4 (i.e., the base end of the housing 10) in order to inspect air and liquid leakages from the air chamber 120 into the gas chamber 110.

FIG. 15 is a diagram in which the test samples are plotted. The abscissa axis indicates (M1+M2)/2. The ordinate axis indicates R′. We analyzed the air- and liquid-tight properties of the samples and evaluated some of the samples within a hatched area as being excellent both in the air tightness and in the liquid tightness of the powder seal 3 and the others as being defective.

From the above test results, it is found that the gas sensor in which the radius of curvature R3 of the corner 41 of the cylindrical insulating seal 4, the radius of curvature R4 of the corner 42 of the cylindrical insulating seal 4, R′ that is a greater one of R3 and R4, the minimum distance M1 between the inside surface 401 of the insulating seal 4 and the sealing wall 205 of the sensor element 2, and the minimum distance M2 between the outside surface 402 of the insulating seal 4 and the inner wall 109 of the housing 10 have the relations of R′≦−4×(M1+M2)/2+0.7, and (M1+M2)/2≧0.025 is excellent in the air and liquid-tight properties.

FIG. 16 is a partially sectional view which shows a gas sensor according to the fifth embodiment of the invention.

If a distance between the upright wall 202 of the sensor element 2 and the upright wall 102 of the housing 10 in the radius direction of the gas sensor 1 is defined as L1 mm, a minimum area of a clearance between the upright wall 202 and the upright wall 102 which traverses the axial direction of the gas sensor is, as clearly illustrated in FIG. 17, defined as S1 mm², and a minimum sectional area of the powder seal 3 traversing the axial direction of the gas sensor is, as clearly illustrated in FIG. 18, defined as S2 mm², they are selected to have relations of S1/S2×100≦10 and L1≦=0.25. For instance, L1=0.15, S1=6, and S2=75.

Other arrangements are identical with those in the first embodiment, and explanation thereof in detail will be omitted here.

We prepared test samples of the gas sensor of the second embodiment having different values of L1, S1, and S2 and performed the above described liquid and air leakage tests on them.

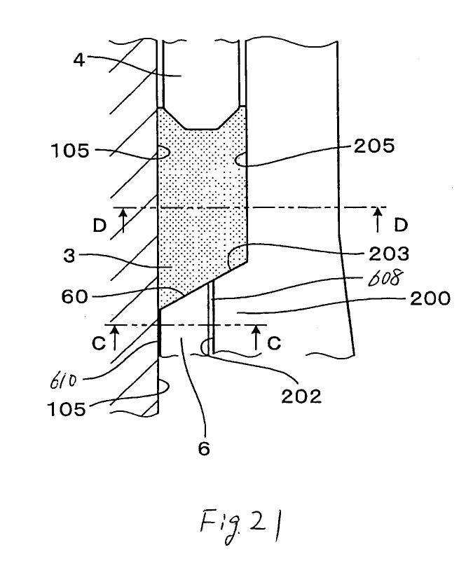

FIG. 19 is a diagram in which the test samples are plotted. The abscissa axis indicates L1. The ordinate axis indicates (S1/S2)×100. We analyzed the air- and liquid-tight properties of the samples and evaluated some of the samples within a hatched area as being excellent both in the air tightness and in the liquid tightness of the powder seal 3 and the others as being defective.

From the above test results, it is found that the gas sensor in which the distance L1 between the upright wall 202 of the sensor element 2 and the upright wall 102 of the housing 10 in the radius direction of the gas sensor 1, the minimum area S1 of the clearance between the upright wall 202 and the upright wall 102 which traverses the axial direction of the gas sensor, and the minimum sectional area S2 of the powder seal 3 traversing the axial direction of the gas sensor have the relations of S1/S2×100≦10, and L1≦0.25 is excellent in the air and liquid-tight properties.

The gas sensor of this embodiment has the minimum sectional area S2 of the powder seal 3 much greater than the area S1 of the clearance between the upright wall 202 and the upright wall 102, so that the powder seal 3 absorbs all air or liquid leaking into the gap between the sensor element 2 and the housing 10 (i.e., the upright walls 202 and 102) to block the entrance thereof into the air chamber 120.

FIGS. 20 to 23 are partially sectional views which show a gas sensor 1 according to the sixth embodiment of the invention.

The gas sensor 1 includes a cylindrical housing 10, an annular porcelain insulator holder 6 retained inside the housing 10, and a sensor element 2 installed inside the porcelain insulator holder 6. The gas sensor 1 also includes a protective cover assembly (not shown) joined to the top end of the housing 10 to cover a sensing portion (i.e., a top portion) of the sensor element 2 and an air cover assembly (not shown) joined to the housing 10 to cover a base end portion (i.e., an upper portion, as viewed in FIG. 20) of the housing 10.

The sensor element 2 has an outer wall 209 on which an annular flange 200 is formed which bulges outward in a radius direction of the sensor element 2. The outer wall 209 also has a sealing surface 205 extending from the flange 200 toward the base end of the sensor element 2.

The flange 200 has a top side tapered wall 201 facing the top end of the sensor element 2, a base side tapered wall 203 facing the base end of the sensor element 2, and an upright wall 202 extending between the top and base side tapered walls 201 and 203.

The housing 10 has an inner wall 109 on which a tapered seat 601 is formed which faces the base end of the housing 10 to bear the porcelain insulator holder 6. The inner wall 109 also includes a sealing wall 105 extending from the tapered seat 601 to the base end of the housing 10.

A gasket 651 is disposed between the seat 601 and the porcelain insulator holder 6. A gasket 652 is disposed between an inner tapered seat of the porcelain insulator holder 6 and the top side tapered wall 201 of the flange 200 of the sensor element 2.

A powder seal 3 is, as clearly shown in FIG. 21, disposed within a hollow cylindrical chamber defined by the sealing wall 205 and the base side tapered wall 203 of the sensor element 2, and the sealing wall 105 and a base end 60 of the porcelain insulator holder 6. A cylindrical insulating seal 4 is also disposed within the chamber in abutment with the powder seal 3.

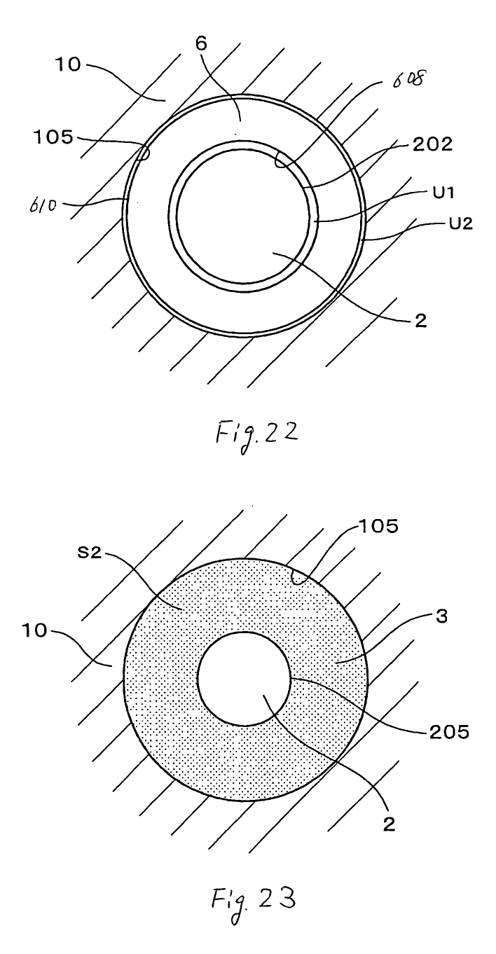

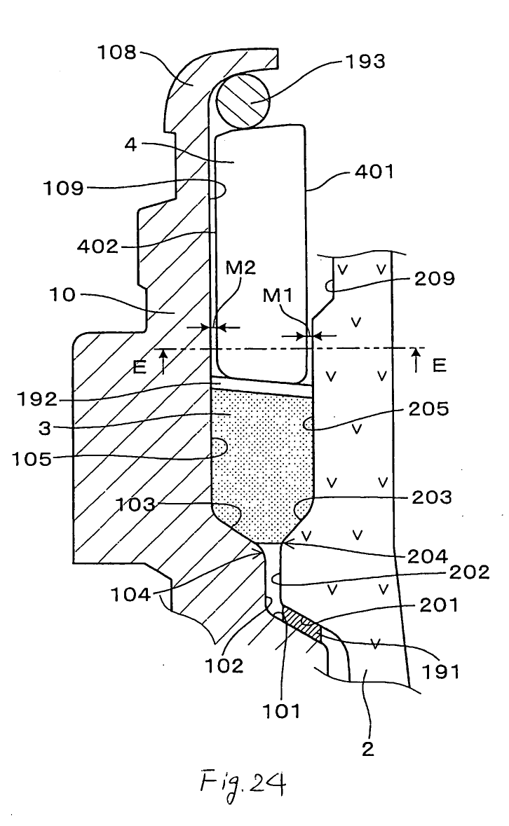

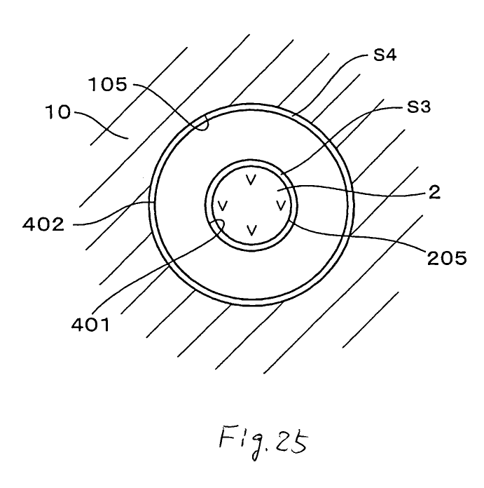

If a minimum area of a clearance between the upright wall 202 of the sensor element 2 and an inside wall 608 of the porcelain insulator holder 6 which traverses the axial direction (i.e., the lengthwise direction) of the gas sensor 1 is, as shown in FIG. 22, defined as U1 mm², a minimum area of a clearance between the sealing wall 105 of the housing 10 and an outside wall 610 of the porcelain insulator holder 6 which traverses the axial direction of the gas sensor 1 is defined as U2 mm², and a minimum sectional area of the powder seal 3 traversing the axial direction of the gas sensor is, as shown in FIG. 23, defined as S2 mm², they are selected to have a relation of (U1+U2)/S2×100≦10. For instance, U1=3, U2=3, and S2=75.

Other arrangements of the gas sensor 1 are identical with those in the first embodiment, and explanation thereof in detail will be omitted here.

The gas sensor 1 of this embodiment has the minimum sectional area S2 of the powder seal 3 much greater than the sum of the transverse sectional areas U1 and U2 of the clearances between the sensor element 2 and the porcelain insulator holder 6 and between the porcelain insulator holder 6 and the housing 10, thus absorbing all gas or liquid in the powder seal 3 to block the entrance thereof into the air chamber 120.

FIGS. 24 and 25 are partially sectional views which show a gas sensor according to the seventh embodiment of the invention which is basically identical in structure with the one, as illustrated in FIG. 1.

If a maximum sectional area of the powder seal 3 traversing the axial direction of the gas sensor is defined as S2 mm², a maximum sectional area of a clearance between the sealing wall 205 of the sensor element 2 and the inside surface 401 of the insulating seal 4 which traverses the axial direction (i.e., the lengthwise direction) of the gas sensor is defined as S3 mm², a maximum sectional area of a clearance between the sealing wall 105 of the housing 10 and the outside surface 402 of the insulating seal 4 is defined as S4 mm², a maximum distance between the inside surface 401 of the insulating seal 4 and the sealing wall 205 of the sensor element 2 is defined as M1 mm, and a maximum distance between the outside surface 402 of the insulating seal 4 and the sealing wall 105 of the housing 10 is defined as M2 mm, they are selected to have relations of [(S3+S4)/S2]×100≦10 and (M1+M2)/2≧0.025. For instance, S2=75, S3=2.5, S4=3.5, M1=0.09, and M2=0.085.

The gas sensor of this embodiment has the minimum sectional area S2 of the powder seal 3 much greater than the sum of the transverse sectional areas S3 and S4 of the clearances between the sensor element 2 and the insulating seal 4 and between the housing 10 and the insulating seal 4, thus absorbing all air or liquid entering from the air chamber 120 in the powder seal 3 to block the leakage thereof into the gas chamber 110 of the protective cover assembly 11.

Usually, the possibility of leakage of air or liquid from the gas chamber 110 also depends upon the size of the clearance around the cylindrical insulating seal 4. Like the gas sensor 1 of the first embodiment constructed to delimit the gap L1 between the sensor element 2 and the housing 10 in order to enhance the air and liquid tight properties of the gas sensor 1, the structure of this embodiment is designed to delimit the average of sizes of gaps between the insulating seal 4 and the sensor element 2 and between the insulating seal 4 and the housing 10 (i.e., M1 and M2) to ensure a desired degree of air/liquid-tight sealing between the housing 10 and the sensor element 2.

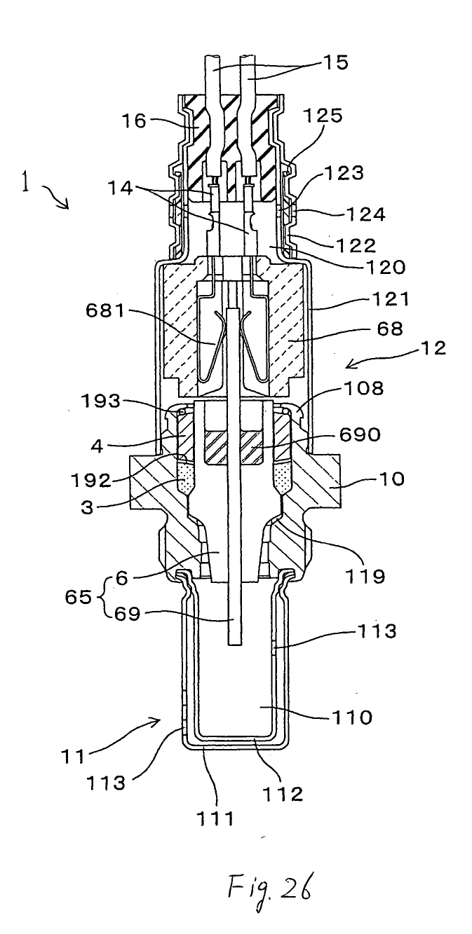

FIG. 26 shows a gas sensor 1 according to the eighth embodiment of the invention.

The gas sensor 1 includes a sensing assembly 65 and a powder seal 690. The sensing assembly 65 is made up of a sensor element 69 and a cylindrical porcelain insulator holder 66. The powder seal 690 is made of, for example, talc, but may be replaced with a glass seal. The sensor element 69 is fitted within the porcelain insulator holder 66 and hermetically sealed by the powder seal 690. The sensing assembly 65 is fitted inside the housing 10. The protective cover assembly 11 is joined to the housing 10 to cover a sensing portion of the sensor element 69. Similarly, the air cover assembly 12 is joined to the housing 10 to cover a base end portion of the sensor element 69.

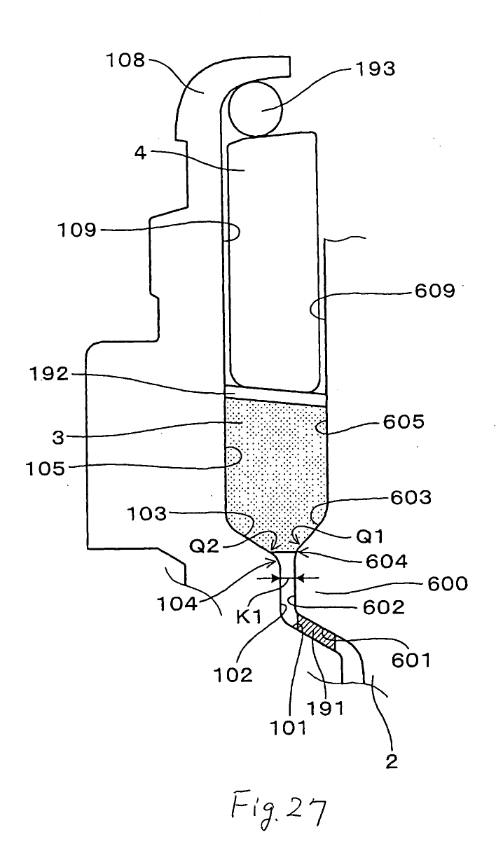

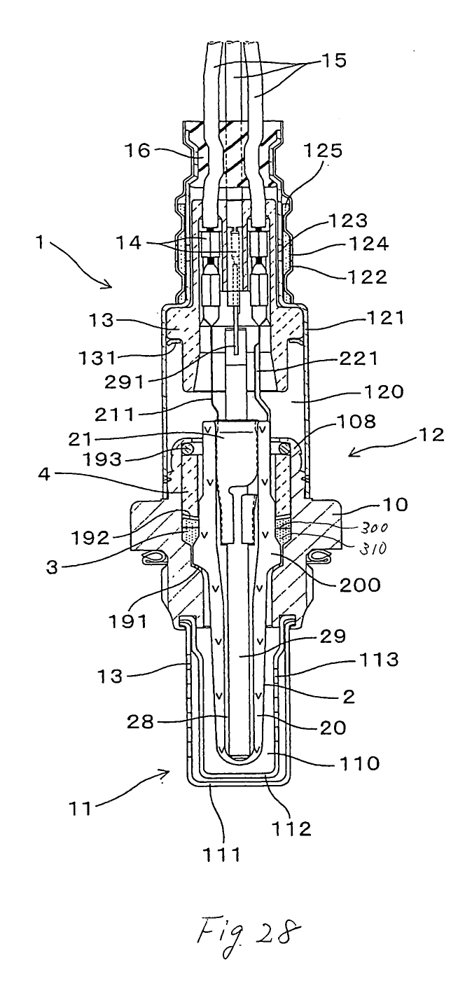

The sensing assembly 69, as clearly shown in FIG. 27, has an outer wall 609 on which an annular flange 600 is formed which bulges outward in a radius direction of the sensing assembly 69. The outer wall 609 also has a sealing surface 605 extending from the flange 600 to the base end of the sensing assembly 69. The flange 600 has a top side tapered wall 601 facing the top end of the sensor element 69, a base side tapered wall 603 facing the base end of the sensor element 69, and an upright wall 602 extending between the top and base side tapered walls 601 and 603. Between the upright wall 602 and the base side tapered wall 603, a corner 604 is formed which is rounded with a radius of curvature Q1 mm.

The housing 10 has an inner wall 109 on which a tapered support wall 101, an upright wall 102, a base side tapered wall 103, and a sealing wall 105 are formed. The support wall 101 bulges inward of the housing 10 to form a seat serving to bear the top side tapered wall 601 of the sensing assembly 65 through a gasket 191. The upright wall 102 extends between the support wall 101 and the base side tapered wall 103. The base side tapered wall 103 is oriented to face the base end of the housing 10. The sealing wall 105 extends from the base side tapered wall 103 to the base end of the housing 10. Formed between the upright wall 102 and the base side tapered wall 103 is a corner 104 rounded with a radius of curvature Q2 mm.

A powder seal 3 is disposed within a cylindrical chamber defined by the sealing wall 605 and the base side tapered wall 603 of the sensing assembly 65, and the sealing wall 105 and the base side tapered wall 103 of the housing 10. A cylindrical insulating seal 4 is also disposed within the chamber in contact with the powder seal 3 through a gasket 192.

The gas sensor 1 also includes a porcelain insulator 68 which is disposed inside an air cover assembly 12. Within the porcelain insulator 68, spring contacts 681 are disposed to make electrical connections between the sensor element 69 and terminal connectors 14 joined to leads 15.

If an interval or distance between the upright wall 602 of the sensing assembly 65 and the upright wall 102 of the housing 10 in a radius direction of the gas sensor 1 (i.e., a direction perpendicular to a length of the gas sensor 1) is defined as L1 mm, and a greater one of Q1 mm and Q2 mm is defined as Qmm, they have relations of Q≦−0.5×K1+2.0, 0<K1≦0.25, 0<Q1≦1.25, and 0<Q2≦1.25 (preferably, 0.01<Q1≦1.25, and 0.01<Q2≦1.25) which ensure, like the first embodiment, an increased degree of air/liquid-tight sealing between the housing 10 and the sensing assembly 65. For instance, K1=0.2, Q1=0.5, and Q2=0.4.

Other arrangements and operations of the gas sensor 1 are identical with those in the first embodiment, and explanation thereof in detail will be omitted here.

A gas sensor of the ninth embodiment of the invention will be described below which is a modification of the one in the eighth embodiment, as illustrated in FIGS. 26 and 27.

The gas sensor, like the eighth embodiment, the sensing assembly 65 made up of the sensor element 69 and the porcelain insulator holder 66. The sensor element 69 is fitted within the porcelain insulator holder 66 and hermetically sealed by the powder seal 690. The sensing assembly 65 is fitted inside the housing 10. The protective cover assembly 11 is joined to the housing 10 to cover a sensing portion of the sensor element 69. Similarly, the air cover assembly 12 is joined to the housing 10 to cover a base end portion of the sensor element 69.

The sensing assembly 65 is basically identical in structure with the one in the eighth embodiment and has the corner 604 formed between the upright wall 602 and the base side tapered wall 603. The corner 604 is rounded with a radius of curvature Q1 mm.

The housing 10 is also identical with the one in the eighth embodiment and has the corner 104 formed between the upright wall 102 and the base side tapered wall 103. The corner 104 is rounded with a radius of curvature Q2 mm.

If an angle which a line extending perpendicular to the axial direction (i.e., the lengthwise direction) of the gas sensor makes with a line extending along the surface of the base side tapered wall 103 of the housing 10 is defined as φ°, and a greater one of Q1 and Q2 is defined as Q, they meet relations of relations of Q≦−0.075×φ+2.75, 0<φ≦25, 0<Q1≦1.25, and 0<Q2≦1.25 which ensure, like the eighth, an increased degree of air/liquid-tight sealing between the housing 10 and the sensing assembly 65. For instance, φ=15°, Q1=0.20, and Q2=0.80.

The outer side surface of the sensing assembly 65 of this embodiment (i.e., the porcelain insulator holder 66) has substantially the same profile as that of the sensor element 2 in the second embodiment illustrated in FIGS. 8 and 9. The dimensional parameters φ°, Q1, and Q2 are, therefore, equivalent in definition to θ, R1, and R2, as referred to in the second embodiment, respectively.

Other arrangements and operations of the gas sensor are identical with those in the eighth embodiment, and explanation thereof in detail will be omitted here.

A gas sensor of the tenth embodiment of the invention will be described below which is a modification of the one in the eighth embodiment, as illustrated in FIGS. 26 and 27.

The sensing assembly 65 and the housing 10 are identical in structure with those in the eighth embodiment.

If a distance between the upright wall 602 of the sensing assembly 65 and the upright wall 102 of the housing 10 in the radius direction of the gas sensor is defined as K1 mm, an intersection between a line extending along the surface of the base side tapered wall 603 of the sensing assembly 65 and a line extending along the surface of the upright wall 602 of the sensing assembly 65 is defined as C, an intersection between a line extending along the surface of the base side tapered wall 103 of the housing 10 and a line extending along the surface of the upright wall 102 of the housing 10 is defined as D, and a minimum distance between the intersections C and D in the axial direction of the gas sensor is defined as [CD]mm, they are selected to meet relations of [CD]≦−10×K1+2.5, 0<K1≦0.25, and 0≦[CD]≦1.5. For instance, [CD]=0.5, and K1=0.15.

The outer side surface of the sensing assembly 65 of this embodiment (i.e., the porcelain insulator holder 66) has substantially the same profile as that of the sensor element 2 in the third embodiment illustrated in FIGS. 11 and 12. The dimensional parameters K1 and [CD] are, therefore, equivalent in definition to K1 and [AB] as referred to in the third embodiment, respectively.

Other arrangements and operations of the gas sensor are identical with those in the eighth embodiment, and explanation thereof in detail will be omitted here.

A gas sensor of the eleventh embodiment of the invention will be described below which is a modification of the one in the eighth embodiment, as illustrated in FIGS. 26 and 27.

The sensing assembly 65 and the housing 10 are identical in structure with those in the eighth embodiment.

If a radius of curvature of a corner of the cylindrical insulating seal 4 closer to the powder seal 3 and the sensing assembly 65 is defined as Q3 mm, a radius of curvature of a corner of the cylindrical insulating seal 4 closer to the powder seal 3 and the housing 10 is defined as Q4 mm, a greater one of Q3 and Q4 is defined as Q′ mm, a distance between an inside surface of the insulating seal 4 and the sealing wall 605 of the sensing assembly 65 is defined as N1 mm, and a distance between an outside surface of the insulating seal 4 and the inner wall 109 of the housing 10 is defined as N2 mm, they are selected to have relations of Q′≦−4×(N1+N2)/2+0.7, and (N1+N2)/2≦0.025. For instance, Q3=0.2, Q4=0.1, N1=0.10, and N2=0.15.

The outer side surface of the sensing assembly 65 of this embodiment (i.e., the porcelain insulator holder 66) has substantially the same profile as that of the sensor element 2 in the fourth embodiment illustrated in FIG. 14. The dimensional parameters Q3, Q4, N1, and N2 are, therefore, equivalent in definition to R3, R4, M1, and M2 as referred to in the fourth embodiment, respectively.

The gas sensor of this embodiment works to absorb air or liquid entering from the air chamber 120 in the powder seal 3 to block the leakage thereof into the gas chamber 110 of the protective cover assembly 11.

Other arrangements and operations of the gas sensor are identical with those in the eighth embodiment, and explanation thereof in detail will be omitted here.

A gas sensor of the twelfth embodiment of the invention will be described below which is a modification of the one in the eighth embodiment, as illustrated in FIGS. 26 and 27.

The sensing assembly 65 and the housing 10 are identical in structure with those in the eighth embodiment.

If a distance between the upright wall 602 of the sensing assembly 65 and the upright wall 102 of the housing 10 in the radius direction of the gas sensor is defined as K1 mm, a transverse sectional area of a clearance between the upright wall 602 and the upright wall 102 which traverses the axial direction of the gas sensor is defined as T1 mm², and a transverse sectional area of the powder seal 3 traversing the axial direction of the gas sensor is defined as T2 mm², they are selected to have relations of T1/T2×100≦10 and K1≦0.25. For instance, K1=0.15, T1=6, and T2=75.

The outer side surface of the sensing assembly 65 of this embodiment (i.e., the porcelain insulator holder 66) has substantially the same profile as that of the sensor element 2 in the fifth embodiment illustrated in FIG. 16. The dimensional parameters K1, T1, and T2 are, therefore, equivalent in definition to L1, S1, and S2 as referred to in the fifth embodiment, respectively.

Other arrangements and operations of the gas sensor are identical with those in the eighth embodiment, and explanation thereof in detail will be omitted here.

A gas sensor of the thirteenth embodiment of the invention will be described below which is a modification of the one in the eighth embodiment, as illustrated in FIGS. 26 and 27.

The sensing assembly 65 and the housing 10 are identical in structure with those in the eighth embodiment, but the sensing assembly 65 is, like the sixth embodiment in FIGS. 20 to 23, seated on the annular porcelain insulator holder 6.

If a transverse sectional area of a clearance between the upright wall 602 of the sensing assembly 65 and the inside wall 608 of the porcelain insulator holder 6 which traverses the axial direction (i.e., the lengthwise direction) of the gas sensor is defined as V1 mm², a transverse sectional area of a clearance between the sealing wall 105 of the housing 10 and the outside wall 610 of the porcelain insulator holder 6 which traverses the axial direction of the gas sensor is defined as V2 mm², and a transverse sectional area of the powder seal 3 traversing the axial direction of the gas sensor is defined as T2 mm², they are selected to have a relation of (V1+V2)/T2×100≦10. For instance, V1=3, V2=3, and T2=75.

The outer side surface of the sensing assembly 65 of this embodiment (i.e., the porcelain insulator holder 66) has substantially the same profile as that of the sensor element 2 in the sixth embodiment illustrated in FIG. 16. The dimensional parameters V1, V2, and T2 are, therefore, equivalent in definition to U1, U2, and S2 as referred to in the sixth embodiment, respectively.

The gas sensor of this embodiment works to absorb air or liquid entering from the air chamber 120 in the powder seal 3 to block the leakage thereof into the gas chamber 110 of the protective cover assembly 11.

Other arrangements and operations of the gas sensor are identical with those in the eighth embodiment, and explanation thereof in detail will be omitted here.

A gas sensor of the fourteenth embodiment of the invention will be described below which is a modification of the one in the eighth embodiment, as illustrated in FIGS. 26 and 27.

The sensing assembly 65 and the housing 10 are identical in structure with those in the eighth embodiment.

If a transverse sectional area of the powder seal 3 traversing the axial direction of the gas sensor is defined as T2 mm², a transverse sectional area of a clearance between the sealing wall 605 of the sensing assembly 65 and an inside surface (401 in FIG. 24) of the insulating seal 4 which traverses the axial direction of the gas sensor is defined as T3 mm², a transverse sectional area of a clearance between the sealing wall 105 of the housing 10 and an outside surface (402 in FIG. 24) of the insulating seal 4 is defined as T4 mm², a distance between the inside surface of the insulating seal 4 and the sealing wall 605 of the sensing assembly 65 is defined as N1 mm, and a distance between the outside surface of the insulating seal 4 and the sealing wall 105 of the housing 10 is defined as N2 mm, they are selected to have relations of [(T3+T4)/T2]×100≦10 and (N1+N2)/2≦0.025. For instance, N1=0.09, N2=0.085, T2=75, T3=2.5, and T4=3.5.

The outer side surface of the sensing assembly 65 of this embodiment (i.e., the porcelain insulator holder 66) has substantially the same profile as that of the sensor element 2 in the seventh embodiment illustrated in FIGS. 24 and 25. The dimensional parameters N1, N2, T2, T3, and T4 are, therefore, equivalent in definition to M1, M2, S2, S3, and S4, as referred to in the seventh embodiment, respectively.

The gas sensor of this embodiment works to absorb air or liquid entering from the air chamber 120 in the powder seal 3 to block the leakage thereof into the gas chamber 110 of the protective cover assembly 11.

Other arrangements and operations of the gas sensor are identical with those in the eighth embodiment, and explanation thereof in detail will be omitted here.

The powder seal 3, as used in each of the above embodiments, may be made of a plurality of annular layers laid to overlap each other. FIG. 28 shows an example of such a structure of the powder seal 3. The powder seal 3 is made up of an upper layer 300 and a lower layer 310 which may be made of compressed powder materials different from each other to enhance the air/liquid sealing properties.

Either or both of the upper and lower layers 300 and 310 may be made of a mixture of talc and sodium primary phoshate or a mixture of talc and aluminosilicate glass. Usually, when sodium primary phoshate or aluminosilicate particles are mixed with talc, they function as fillers occupying spaces between particles of the talc, thus enhancing adhesion between the particles to make the powder seal 3 more dense, which improves the air/liquid tightness of the powder seal 3 and also minimizes capillary attraction of molecules of gas or liquid into the powder seal 3.

Either or both of the upper and lower layers 300 and 310 preferably contains fillers made of sodium primary phoshate in an amount of 0.1 to 10 parts by weight per 100 parts by weight of a main powder material such as talc. When the fillers are contained in an amount of less than 0.1 parts by weight, it may result in lack of density of the powder seal 3 to ensure a desired level of tightness thereof. Conversely, when the filters are contained in an amount of more than 10 parts by weight, they may become obstacles to compression of the powder seal 3, thus resulting in lack of specific gravity of the powder seal 3.

The fillers may be made of at least one of barium hydroxide, borosilicate glass, aluminosilicate glass, soda-lime silicate glass, lead silicate glass, low-melting borate glass, lime-alumina-glass, and aluminate glass. These materials are easy to liquefy and thus may be heated to increase the density of the powder seal 3. Particularly, they are preferable to block pore spaces between particles of talc through which liquid such as fuel contained in exhaust emissions of the engine passes. The fillers may be contained in an amount of 0.5 to 30 parts by weight per 100 parts by weight of a main powder material.

The powder seal 3 may be made by compressing a powder material containing 80% or more by weight of particles having a diameter of 80μ to 1000 μm per 100% by weight of the entire powder material. Usually, larger particles each hardly contain air. The particles which are compressed and broken may, therefore, be used as material of the powder seal 3 which becomes high in relative density when jammed into the gas sensor 1. If the size of the particles is greater than 1000μ, it may result in a great variation in density of the powder seal 3, thus lowering the tightness thereof.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

1. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal, wherein if a radius of curvature of the corner of the bulging portion of said sensor element is defined as R1 mm, a radius of curvature of the corner of said housing is defined as R2 mm, a greater one of R1 mm and R2 mm is defined as R1 mm, and a distance between the upright walls of said housing and the bulging portion of said sensor element in a transverse direction perpendicular to a length of the gas sensor is defined as L1 mm, they meet relations of R≦−0.5×L1+2.0, 0<L1≦0.25, 0<R1≦1.25, and 0<R2≦1.25.

2. A gas sensor as set forth in claim 1, wherein the radius of curvatures R1 and R2 have relations of 0.01≦R1≦1.25, and 0.01≦R2≦1.25, respectively.

3. A gas sensor as set forth in claim 1, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

4. A gas sensor as set forth in claim 1, wherein said powder seal is made up of a plurality of layers laid overlap each other.

5. A gas sensor as set forth in claim 1, wherein said powder seal is made of a first and a second compressed powder component, the first compressed powder component containing 80 or more parts by weight of particles having a diameter of 80 to 1000 μm per 100 parts by weight of the second compressed powder component.

6. A gas sensor as set forth in claim 4, wherein at least one of the layers of said powder seal is made of a mixture of powders and fillers.

7. A gas sensor as set forth in claim 5, wherein at least one of the layers of said powder seal is made of a mixture of powders and fillers.

8. A gas sensor as set forth in claim 6, wherein said fillers are made of sodium primary phoshate.

9. A gas sensor as set forth in claim 6, wherein said fillers are contained in an amount of 0.1 to 10 parts per 100 parts by weight of the powders.

10. A gas sensor as set forth in claim 6, wherein the fillers are made of at least one of barium hydroxide, borosilicate glass, aluminosilicate glass, soda-lime silicate glass, lead silicate glass, low-melting borate glass, lime-alumina-glass, and aluminate glass.

11. A gas sensor as set forth in claim 10, wherein the fillers are contained in an amount of 0.5 to 30 parts by weight per 100 parts by weight of the powders.

12. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal,
wherein if a radius of curvature of the corner of the bulging portion of said sensor element is defined as R1 mm, a radius of curvature of the corner of said housing is defined as R2 mm, a greater one of R1 mm and R2 mm is defined as Rmm, and an angle which a line extending in a transverse direction perpendicular to a length of the gas sensor makes with a line extending along the base side tapered surface of said housing θ°, they meet relations of R≦−0.075×θ+2.75, 0≦θ≦25, 0<R1≦1.25, and 0<R2≦1.25.

13. A gas sensor as set forth in claim 12, wherein the radius of curvatures R1 and R2 have relations of 0.01≦R1≦1.25, and 0.01≦R2≦1.25, respectively.

14. A gas sensor as set forth in claim 12, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

15. A gas sensor as set forth in claim 12, wherein said powder seal is made up of a plurality of layers laid overlap each other.

16. A gas sensor as set forth in claim 12, wherein said powder seal is made of a first and a second compressed powder component, the first compressed powder component containing 80 or more parts by weight of particles having a diameter of 80 to 1000 μm per 100 parts by weight of the second compressed powder component.

17. A gas sensor as set forth in claim 15, wherein at least one of the layers of said powder seal is made of a mixture of powders and fillers.

18. A gas sensor as set forth in claim 17, wherein said fillers are made of sodium primary phoshate.

19. A gas sensor as set forth in claim 17, wherein said fillers are contained in an amount of 0.1 to 10 parts per 100 parts by weight of the powders.

20. A gas sensor as set forth in claim 17, wherein the fillers are made of at least one of barium hydroxide, borosilicate glass, aluminosilicate glass, soda-lime silicate glass, lead silicate glass, low-melting borate glass, lime-alumina-glass, and aluminate glass.

21. A gas sensor as set forth in claim 20, wherein the fillers are contained in an amount of 0.5 to 30 parts by weight per 100 parts by weight of the powders.

22. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal,
wherein if a distance between the upright walls of said housing and the bulging portion of said sensor element in a transverse direction perpendicular to a length of the gas sensor is defined as L1 mm, an intersection between lines extending along the base side tapered surface and the upright surface of said sensor element is defined as A, an intersection between lines extending along the base side tapered surface and the upright surface of said housing is defined as B, and a distance between the intersections A and B along a line extending in a lengthwise direction of the gas sensor is defined as [AB]mm, they meet relations of [AB]≦−10×L1+2.5, 0<L1≦0.25, and 0≦[AB]≦1.5.

23. A gas sensor as set forth in claim 22, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3+, they meet relations of 0≦θ1≦50, 0≦θ2≦50, and 120≦θ3≦180 where θ1+θ2+θ3=180°.

24. A gas sensor as set forth in claim 22, wherein said powder seal is made up of a plurality of layers laid overlap each other.

25. A gas sensor as set forth in claim 22, wherein said powder seal is made of a first and a second compressed powder component, the first compressed powder component containing 80 or more parts by weight of particles having a diameter of 80 to 1000 μm per 100 parts by weight of the second compressed powder component.

26. A gas sensor as set forth in claim 24, wherein at least one of the layers of said powder seal is made of a mixture of powders and fillers.

27. A gas sensor as set forth in claim 26, wherein said fillers are made of sodium primary phoshate.

28. A gas sensor as set forth in claim 26, wherein said fillers are contained in an amount of 0.1 to 10 parts per 100 parts by weight of the powders.

29. A gas sensor as set forth in claim 26, wherein the fillers are made of at least one of barium hydroxide, borosilicate glass, aluminosilicate glass, soda-lime silicate glass, lead silicate glass, low-melting borate glass, lime-alumina-glass, and aluminate glass.

30. A gas sensor as set forth in claim 29, wherein the fillers are contained in an amount of 0.5 to 30 parts by weight per 100 parts by weight of the powders.

31. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal,
wherein if a radius of curvature of a corner of the said insulating seal facing said powder seal and said sensor element is defined as R3 mm, a radius of curvature of a corner of said insulating seal facing said powder seal and said housing is defined as R4 mm, a greater one of R3 mm and R4 mm is defined as R′ mm, a distance between an inside surface of said insulating seal and the sealing surface of said sensor element is defined as M1 mm, and a distance between an outside surface of said insulating seal and the sealing surface of said housing is defined as M2 mm, they meet relations of R′≦−4×(M1+M2)/2+0.7 and (M1+M2)/2≧0.025.

32. A gas sensor as set forth in claim 31, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

33. A gas sensor as set forth in claim 31, wherein said powder seal is made up of a plurality of layers laid overlap each other.

34. A gas sensor as set forth in claim 31, wherein said powder seal is made of a first and a second compressed powder component, the first compressed powder component containing 80 or more parts by weight of particles having a diameter of 80 to 1000 μm per 100 parts by weight of the second compressed powder component.

35. A gas sensor as set forth in claim 33, wherein at least one of the layers of said powder seal is made of a mixture of powders and fillers.

36. A gas sensor as set forth in claim 35, wherein said fillers are made of sodium primary phoshate.

37. A gas sensor as set forth in claim 35, wherein said fillers are contained in an amount of 0.1 to 10 parts per 100 parts by weight of the powders.

38. A gas sensor as set forth in claim 35, wherein the fillers are made of at least one of barium hydroxide, borosilicate glass, aluminosilicate glass, soda-lime silicate glass, lead silicate glass, low-melting borate glass, lime-alumina-glass, and aluminate glass.

39. A gas sensor as set forth in claim 38, wherein the fillers are contained in an amount of 0.5 to 30 parts by weight per 100 parts by weight of the powders.

40. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal,
wherein if a distance between the upright surfaces of said sensor element and said housing in a transverse direction perpendicular to a length of the gas sensor is defined as L1 mm, a sectional area of a clearance between the upright surfaces of said sensor element and said housing in the transverse direction of the gas sensor is defined as S1 mm², and a sectional area of said powder seal in the transverse direction of the gas sensor is defined as S2 mm², they have relations of S1/S2×100≦10 and L1≦0.25.

41. A gas sensor as set forth in claim 40, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

42. A gas sensor as set forth in claim 40, wherein said powder seal is made up of a plurality of layers laid overlap each other.

43. A gas sensor as set forth in claim 40, wherein said powder seal is made of a first and a second compressed powder component, the first compressed powder component containing 80 or more parts by weight of particles having a diameter of 80 to 1000 μm per 100 parts by weight of the second compressed powder component.

44. A gas sensor as set forth in claim 42, wherein at least one of the layers of said powder seal is made of a mixture of powders and fillers.

45. A gas sensor as set forth in claim 44, wherein said fillers are made of sodium primary phoshate.

46. A gas sensor as set forth in claim 44, wherein said fillers are contained in an amount of 0.1 to 10 parts per 100 parts by weight of the powders.

47. A gas sensor as set forth in claim 44, wherein the fillers are made of at least one of barium hydroxide, borosilicate glass, aluminosilicate glass, soda-lime silicate glass, lead silicate glass, low-melting borate glass, lime-alumina-glass, and aluminate glass.

48. A gas sensor as set forth in claim 47, wherein the fillers are contained in an amount of 0.5 to 30 parts by weight per 100 parts by weight of the powders.

49. A gas sensor comprising:
a hollow cylindrical housing having a top end and a base end opposed to the top end, said housing having formed on an inner wall thereof a tapered seat and a sealing surface extending from the tapered seat toward the base end of said housing;
a hollow cylindrical porcelain insulator holder having a base side end, a top side end, and an inner surface with a seat, said insulator holder being seated on the tapered seat of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, and an upright surface between the top side and base side tapered surfaces, said sensor element being disposed within said housing and supported at the top side tapered surface thereof on the seat formed on the inner surface of said insulator holder;
an air cover joined to the base end of said housing to surround the base portion of said sensor element;
a gas cover joined to the top end of said housing to surround the top portion of said sensor element;
an annular chamber defined by the sealing surface and the base side tapered surface of said sensor element, the sealing surface of said housing, and the base end of said insulator holder;
a powder seal with a top end and a base end, said powder seal being disposed at the top end thereof on the base side tapered surface of said sensor element and the base end of said insulator holder within said annular chamber; and
a cylindrical insulating seal disposed on the base end of said powder seal,
wherein if a sectional area of a clearance between the upright surface of said sensor element and the inner surface of said insulator holder in a transverse direction perpendicular to a length of the sensor element is defined as U1 mm², a sectional area of a clearance between the sealing surface of said housing and an outer surface of said insulator holder in the transverse direction is defined as U2 mm², and a sectional area of the powder seal in the transverse direction is defined as S2 mm², they have a relation of (U1+U2)/S2×100≦10.

50. A gas sensor as set forth in claim 49, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

51. A gas sensor as set forth in claim 49, wherein said powder seal is made up of a plurality of layers laid overlap each other.

52. A gas sensor as set forth in claim 49, wherein said powder seal is made of a first and a second compressed powder component, the first compressed powder component containing 80 or more parts by weight of particles having a diameter of 80 to 1000 μm per 100 parts by weight of the second compressed powder component.

53. A gas sensor as set forth in claim 51, wherein at least one of the layers of said powder seal is made of a mixture of powders and fillers.

54. A gas sensor as set forth in claim 53, wherein said fillers are made of sodium primary phoshate.

55. A gas sensor as set forth in claim 53, wherein said fillers are contained in an amount of 0.1 to 10 parts per 100 parts by weight of the powders.

56. A gas sensor as set forth in claim 53, wherein the fillers are made of at least one of barium hydroxide, borosilicate glass, aluminosilicate glass, soda-lime silicate glass, lead silicate glass, low-melting borate glass, lime-alumina-glass, and aluminate glass.

57. A gas sensor as set forth in claim 56, wherein the fillers are contained in an amount of 0.5 to 30 parts by weight per 100 parts by weight of the powders.

58. A gas sensor comprising:
a hollow cylindrical housing having a top end and a base end opposed to the top end, said housing having formed on an inner wall thereof a base side tapered surface, an upright surface, a tapered support surface, a corner and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensor element disposed in said housing, said sensor element having a length made up of a base portion and a top portion which is to be exposed to a gas to be sensed, said sensor element having also formed on an outer wall thereof a portion which bulges outward in a transverse direction perpendicular to the length thereof and a sealing surface which extends from the bulging portion toward a base end of the base portion, the bulging portion including a top side tapered surface oriented toward a top end of the top portion, a base side tapered surface oriented toward the base end of the base portion, an upright surface between the top side and base side tapered surfaces, and a corner between the base side tapered surface and the upright surface, said sensor element being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the base side tapered surface and the sealing surface of said housing and the base side tapered surface and the sealing surface of said sensor element;
a powder seal with a top end and a base end, said powder seal being disposed at the top end thereof on the base side tapered surfaces of said housing and said sensor element within said annular chamber; and
a cylindrical insulating seal disposed on the base end of said powder seal,
wherein if a sectional area of said powder seal in a transverse direction perpendicular to a length of the gas sensor is defined as S2 mm², a sectional area of a clearance between the sealing surface of said sensor element and an inner surface of said insulating seal in the transverse direction is defined as S3 mm², a sectional area of a clearance between the sealing surface of said housing and an outer surface of the insulating seal is defined as S4 mm², a distance between the inner surface of said insulating seal and the sealing surface of said sensor element is defined as M1 mm, and a distance between the outer surface of said insulating seal and the sealing surface of said housing is defined as M2 mm, they have relations of [(S3+S4)/S2]×100≦10, and (M1+M2)/2≧0.025.

59. A gas sensor as set forth in claim 58, wherein said powder seal has a bottom abutting the base side tapered surfaces of said sensor element and said housing, the bottom including an inner tapered surface facing the base side tapered surface of said sensor element and an outer tapered surface facing the base side tapered surface of said housing, and wherein if an angle which a first line extending along the inner tapered surface makes with a lateral line extending in a transverse direction perpendicular to a length of the gas sensor is defined as θ1°, an angle which a second line extending along the outer tapered surface makes with the lateral line is defined as θ2°, and an angle which the first line makes with the second line is defined as θ3°, they meet relations of 0≦θ1≦50, 0≦θ2≦50, and 120≦θ3≦180 where θ1+θ2+θ3=180°.

60. A gas sensor as set forth in claim 58, wherein said powder seal is made up of a plurality of layers laid overlap each other.

61. A gas sensor as set forth in claim 58, wherein said powder seal is made of a first and a second compressed powder component, the first compressed powder component containing 80 or more parts by weight of particles having a diameter of 80 to 1000 μm per 100 parts by weight of the second compressed powder component.

62. A gas sensor as set forth in claim 60, wherein at least one of the layers of said powder seal is made of a mixture of powders and fillers.

63. A gas sensor as set forth in claim 62, wherein said fillers are made of sodium primary phoshate.

64. A gas sensor as set forth in claim 62, wherein said fillers are contained in an amount of 0.1 to 10 parts per 100 parts by weight of the powders.

65. A gas sensor as set forth in claim 62, wherein the fillers are made of at least one of barium hydroxide, borosilicate glass, aluminosilicate glass, soda-lime silicate glass, lead silicate glass, low-melting borate glass, lime-alumina-glass, and aluminate glass.

66. A gas sensor as set forth in claim 65, wherein the fillers are contained in an amount of 0.5 to 30 parts by weight per 100 parts by weight of the powders.

67. A gas sensor comprising:
a hollow cylindrical housing having a top end and a base end opposed to the top end, said housing having formed on an inner wall thereof a base side tapered surface, an upright surface, a tapered support surface, a corner, and a sealing surface, the upright surface extending from the base side tapered surface toward the top end through the corner, the tapered support surface extending from the upright surface more inwardly than the base side tapered surface toward the top end, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, an upright surface between the top side and base side tapered surfaces, and a corner between the bas side tapered surface and the upright surface, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of said porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if radiuses of curvature of the corners of the porcelain insulator of said sensing assembly and said housing are defined as Q1 mm and Q2 mm, respectively, a greater one of Q1 mm and Q2 mm is defined as Qmm, and a distance between the upright surfaces of said housing and the porcelain insulator of said sensing assembly in a transverse direction perpendicular to a length of the gas sensor is defined as K1, they have relations of Q≦−0.5×K1+2.0, 0<K1≦0.25, 0<Q1≦1.25, and 0<Q2≦1.25.

68. A gas sensor as set forth in claim 67, wherein the radius of curvatures Q1 and Q2 have relations of 0.01≦Q1≦1.25, and 0.01≦Q2≦1.25, respectively.

69. A gas sensor as set forth in claim 67, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

70. A gas sensor as set forth in claim 68, wherein said powder seal is made up of a plurality of layers laid overlap each other.

71. A gas sensor as set forth in claim 68, wherein said powder seal is made of a first and a second compressed powder component, the first compressed powder component containing 80 or more parts by weight of particles having a diameter of 80 to 1000 μm per 100 parts by weight of the second compressed powder component.

72. A gas sensor as set forth in claim 70, wherein at least one of the layers of said powder seal is made of a mixture of powders and fillers.

73. A gas sensor as set forth in claim 72, wherein said fillers are made of sodium primary phoshate.

74. A gas sensor as set forth in claim 72, wherein said fillers are contained in an amount of 0.1 to 10 parts per 100 parts by weight of the powders.

75. A gas sensor as set forth in claim 72, wherein the fillers are made of at least one of barium hydroxide, borosilicate glass, aluminosilicate glass, soda-lime silicate glass, lead silicate glass, low-melting borate glass, lime-alumina-glass, and aluminate glass.

76. A gas sensor as set forth in claim 75, wherein the fillers are contained in an amount of 0.5 to 30 parts by weight per 100 parts by weight of the powders.

77. A gas sensor comprising:
a hollow cylindrical housing having a top end and a base end opposed to the top end, said housing having formed on an inner wall thereof a base side tapered surface, an upright surface, a tapered support surface, a corner, and a sealing surface, the upright surface extending from the base side tapered surface toward the top end through the corner, the tapered support surface extending from the upright surface more inwardly than the base side tapered surface toward the top end thereof, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, an upright surface between the top side and base side tapered surfaces, and a corner between the bas side tapered surface and the upright surface, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of the porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if radiuses of curvature of the corners of the porcelain insulator of said sensing assembly and said housing are defined as Q1 mm and Q2 mm, respectively, a greater one of Q1 mm and Q2 mm is defined as Qmm, and an angle which a line extending perpendicular to a length of the gas sensor makes with a line extending along the base side tapered surface of said housing is defined as φ°, they meet relations of relations of Q≦−0.075×φ+2.75, 0<φ≦25, 0<Q1≦1.25, and 0<Q2≦1.25.

78. A gas sensor as set forth in claim 77, wherein the radius of curvatures Q1 and Q2 have relations of 0.01≦Q1≦1.25, and 0.01≦Q2≦1.25, respectively.

79. A gas sensor as set forth in claim 77, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

80. A gas sensor as set forth in claim 77, wherein said powder seal is made up of a plurality of layers laid overlap each other.

81. A gas sensor as set forth in claim 77, wherein said powder seal is made of a first and a second compressed powder component, the first compressed powder component containing 80 or more parts by weight of particles having a diameter of 80 to 1000 μm per 100 parts by weight of the second compressed powder component.

82. A gas sensor as set forth in claim 80, wherein at least one of the layers of said powder seal is made of a mixture of powders and fillers.

83. A gas sensor as set forth in claim 82, wherein said fillers are made of sodium primary phoshate.

84. A gas sensor as set forth in claim 82, wherein said fillers are contained in an amount of 0.1 to 10 parts per 100 parts by weight of the powders.

85. A gas sensor as set forth in claim 82, wherein the fillers are made of at least one of barium hydroxide, borosilicate glass, aluminosilicate glass, soda-lime silicate glass, lead silicate glass, low-melting borate glass, lime-alumina-glass, and aluminate glass.

86. A gas sensor as set forth in claim 85, wherein the fillers are contained in an amount of 0.5 to 30 parts by weight per 100 parts by weight of the powders.

87. A gas sensor comprising:
a hollow cylindrical housing having a top end and a base end opposed to the top end, said housing having formed on an inner wall thereof a base side tapered surface, an upright surface, a tapered support surface, and a sealing surface, the upright surface extending from the base side tapered surface toward the top end, the tapered support surface extending from the upright surface more inwardly than the base side tapered surface toward the top end thereof, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, and an upright surface between the top side and base side tapered surfaces, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of the porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if a distance between the upright surfaces of said sensing assembly and said housing in a transverse direction perpendicular to a length of the gas sensor is defined as K1 mm, an intersection between a line extending along the base side tapered surface of said sensing assembly and a line extending along the upright surface of said sensing assembly is defined as C, an intersection between a line extending along the base side tapered surface of said housing and a line extending along the upright surface of said housing is defined as D, and a distance between the intersections C and D along a line extending in a lengthwise direction of the gas sensor is defined as [CD]mm, they meet relations of [CD]≦−10×K1+2.5, 0<K1≦0.25, and 0≦[CD]≦1.5.

88. A gas sensor as set forth in claim 87, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

89. A gas sensor as set forth in claim 87, wherein said powder seal is made up of a plurality of layers laid overlap each other.

90. A gas sensor as set forth in claim 87, wherein said powder seal is made of a first and a second compressed powder component, the first compressed powder component containing 80 or more parts by weight of particles having a diameter of 80 to 1000 μm per 100 parts by weight of the second compressed powder component.

91. A gas sensor as set forth in claim 89, wherein at least one of the layers of said powder seal is made of a mixture of powders and fillers.

92. A gas sensor as set forth in claim 91, wherein said fillers are made of sodium primary phoshate.

93. A gas sensor as set forth in claim 91, wherein said fillers are contained in an amount of 0.1 to 10 parts per 100 parts by weight of the powders.

94. A gas sensor as set forth in claim 91, wherein the fillers are made of at least one of barium hydroxide, borosilicate glass, aluminosilicate glass, soda-lime silicate glass, lead silicate glass, low-melting borate glass, lime-alumina-glass, and aluminate glass.

95. A gas sensor as set forth in claim 94, wherein the fillers are contained in an amount of 0.5 to 30 parts by weight per 100 parts by weight of the powders.

96. A gas sensor comprising:
a hollow cylindrical housing having a top end and a base end opposed to the top end, said housing having formed on an inner wall thereof a base side tapered surface, an upright surface, a tapered support surface, and a sealing surface, the upright surface extending from the base side tapered surface toward the top end, the tapered support surface extending from the upright surface more inwardly than the base side tapered surface toward the top end thereof, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, and an upright surface between the top side and base side tapered surfaces, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of the porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if a radius of curvature of a corner of said cylindrical insulating seal closer to said powder seal and said sensing assembly is defined as Q3 mm, a radius of curvature of a corner of said cylindrical insulating seal closer to said powder seal and said housing is defined as Q4 mm, a greater one of Q3 mm and Q4 mm is defined as Q′ mm, a distance between an inner surface of said insulating seal and the sealing surface of said sensing assembly is defined as N1 mm. and a distance between an outer surface of said insulating seal and the sealing surface of said housing is defined as N2 mm, they have relations of Q′≦−4×(N1+N2)/2+0.7, and (N1+N2)/2≧0.025.

97. A gas sensor as set forth in claim 96, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

98. A gas sensor as set forth in claim 96, wherein said powder seal is made up of a plurality of layers laid overlap each other.

99. A gas sensor as set forth in claim 96, wherein said powder seal is made of a first and a second compressed powder component, the first compressed powder component containing 80 or more parts by weight of particles having a diameter of 80 to 1000 μm per 100 parts by weight of the second compressed powder component.

100. A gas sensor as set forth in claim 98, wherein at least one of the layers of said powder seal is made of a mixture of powders and fillers.

101. A gas sensor as set forth in claim 100, wherein said fillers are made of sodium primary phoshate.

102. A gas sensor as set forth in claim 100, wherein said fillers are contained in an amount of 0.1 to 10 parts per 100 parts by weight of the powders.

103. A gas sensor as set forth in claim 100, wherein the fillers are made of at least one of barium hydroxide, borosilicate glass, aluminosilicate glass, soda-lime silicate glass, lead silicate glass, low-melting borate glass, lime-alumina-glass, and aluminate glass.

104. A gas sensor as set forth in claim 103, wherein the fillers are contained in an amount of 0.5 to 30 parts by weight per 100 parts by weight of the powders.

105. A gas sensor comprising:
a hollow cylindrical housing having a top end and a base end opposed to the top end, said housing having formed on an inner wall thereof a base side tapered surface, an upright surface, a tapered support surface, and a sealing surface, the upright surface extending from the base side tapered surface toward the top end, the tapered support surface extending from the upright surface more inwardly than the base side tapered surface toward the top end thereof, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, and an upright surface between the top side and base side tapered surfaces, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of the porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if a distance between the upright surfaces of said sensing assembly and said housing in a transverse direction perpendicular to a length of the sensor element is defined as K1 mm, a sectional area of a clearance between the upright surfaces of said sensing assembly and said housing which extends in the transverse direction is defined as T1 mm², and a sectional area of said powder seal extending in the transverse direction is defined as T2 mm², they have relations of T1/T2×100≦10, and K1≦0.25.

106. A gas sensor as set forth in claim 105, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

107. A gas sensor as set forth in claim 105, wherein said powder seal is made up of a plurality of layers laid overlap each other.

108. A gas sensor as set forth in claim 105, wherein said powder seal is made of a first and a second compressed powder component, the first compressed powder component containing 80 or more parts by weight of particles having a diameter of 80 to 1000 μm per 100 parts by weight of the second compressed powder component.

109. A gas sensor as set forth in claim 107, wherein at least one of the layers of said powder seal is made of a mixture of powders and fillers.

110. A gas sensor as set forth in claim 109, wherein said fillers are made of sodium primary phoshate.

111. A gas sensor as set forth in claim 109, wherein said fillers are contained in an amount of 0.1 to 10 parts per 100 parts by weight of the powders.

112. A gas sensor as set forth in claim 109, wherein the fillers are made of at least one of barium hydroxide, borosilicate glass, aluminosilicate glass, soda-lime silicate glass, lead silicate glass, low-melting borate glass, lime-alumina-glass, and aluminate glass.

113. A gas sensor as set forth in claim 112, wherein the fillers are contained in an amount of 0.5 to 30 parts by weight per 100 parts by weight of the powders.

114. A gas sensor comprising:
a hollow cylindrical housing having a top end and a base end opposed to the top end, said housing having formed on an inner wall thereof a tapered seat and a sealing surface extending from the tapered seat toward the base end of said housing;
a hollow cylindrical porcelain insulator holder having a base side end, a top side end, and an inner surface with a seat, said insulator holder being seated on the tapered seat of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward a top end of the top portion, a base side tapered surface oriented toward the base end of the base portion, and an upright surface between the top side and base side tapered surfaces, the porcelain insulator being disposed within said housing and supported at the top side tapered surface thereof on the seat formed on the inner surface of said insulator holder;
an air cover joined to the base end of said housing to surround the base portion of said sensor element;
a gas cover joined to the top end of said housing to surround the top portion of said sensor element;
an annular chamber defined by the sealing surface and the base side tapered surface of said sensing assembly, the sealing surface of said housing, and the base end of said insulator holder;
a powder seal with a top end and a base end, said powder seal being disposed at the top end thereof on the base side tapered surface of said sensing assembly and the base end of said insulator holder within said annular chamber; and
a cylindrical insulating seal disposed on the base end of said powder seal,
wherein if a transverse sectional area of a clearance between the upright surface of said sensing assembly and an inner surface of said insulator holder which extends in a transverse direction perpendicular to a length of the gas sensor is defined as V1 mm², a transverse sectional area of a clearance between the sealing surface of said housing and an outer surface of said insulator holder which extends in the transverse direction is defined as V2 mm², and a transverse sectional area of said powder seal extending in the transverse direction is defined as T2 mm², they have a relation of (V1+V2)/T2×100≦10.

115. A gas sensor as set forth in claim 114, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

116. A gas sensor as set forth in claim 114, wherein said powder seal is made up of a plurality of layers laid overlap each other.

117. A gas sensor as set forth in claim 114, wherein said powder seal is made of a first and a second compressed powder component, the first compressed powder component containing 80 or more parts by weight of particles having a diameter of 80 to 1000 μm per 100 parts by weight of the second compressed powder component.

118. A gas sensor as set forth in claim 116, wherein at least one of the layers of said powder seal is made of a mixture of powders and fillers.

119. A gas sensor as set forth in claim 118, wherein said fillers are made of sodium primary phoshate.

120. A gas sensor as set forth in claim 118, wherein said fillers are contained in an amount of 0.1 to 10 parts per 100 parts by weight of the powders.

121. A gas sensor as set forth in claim 118, wherein the fillers are made of at least one of barium hydroxide, borosilicate glass, aluminosilicate glass, soda-lime silicate glass, lead silicate glass, low-melting borate glass, lime-alumina-glass, and aluminate glass.

122. A gas sensor as set forth in claim 121, wherein the fillers are contained in an amount of 0.5 to 30 parts by weight per 100 parts by weight of the powders.

123. A gas sensor comprising:
a hollow cylindrical housing having a top end and a base end opposed to the top end, said housing having formed on an inner wall thereof a base side tapered surface, an upright surface, a tapered support surface, and a sealing surface, the upright surface extending from the base side tapered surface toward the top end, the tapered support surface extending from the upright surface more inwardly than the base side tapered surface toward the top end thereof, the sealing surface extending from the base side tapered surface toward the base end of said housing;
a sensing assembly disposed within said housing and having a top end and a base end, said sensing assembly being made up of a cylindrical porcelain insulator and a sensor element fitted in the porcelain insulator, the sensor element having a length made up of a base portion and a top portion which is to be exposed to a gas to be sensed, the cylindrical porcelain insulator having a top end and a base end and also formed on an outer wall thereof a portion which bulges outward in a transverse direction perpendicular to a length thereof and a sealing surface which extends from the bulging portion toward the base end thereof, the bulging portion including a top side tapered surface oriented toward the top end thereof, a base side tapered surface oriented toward the base end thereof, and an upright surface between the top side and base side tapered surfaces, said porcelain insulator being disposed within said housing and supported at the top side tapered surface thereof on the tapered support surface of said housing;
an air cover joined to the base end of said housing to surround the base portion of said sensor element;
a gas cover joined to the top end of said housing to surround the top portion of said sensor element;
an annular chamber defined by the sealing surface and the base side tapered surface of the porcelain insulator of said sensing assembly and the sealing surface and the base side tapered surface of said housing;
a powder seal with a top end and a base end, said powder seal being disposed at the top end thereof on the base side tapered surfaces of the porcelain insulator of said sensing assembly and said housing within said annular chamber; and
a cylindrical insulating seal disposed on the base end of said powder seal,
wherein if a transverse sectional area of said powder seal extending in a transverse direction perpendicular to a length of the gas sensor is defined as T2 mm², a transverse sectional area of a clearance between the sealing surface of said sensing assembly and an inside surface of said insulating seal which extends in the transverse direction is defined as T3 mm², a transverse sectional area of a clearance between the sealing surface of said housing and an outside surface of said insulating seal is defined as T4 mm², a distance between the inside surface of said insulating seal and the sealing surface of said sensing assembly is defined as N1 mm, and a distance between the outside surface of said insulating seal and the sealing surface of said housing is defined as N2 mm, they have relations of [(T3+T4)/T2]×100≦10, and (N1+N2)/2≧0.025.

124. A gas sensor as set forth in claim 123, wherein said powder seal has a bottom abutting the base side tapered surfaces of said sensing assembly and said housing, the bottom including an inner tapered surface facing the base side tapered surface of said sensing assembly and an outer tapered surface facing the base side tapered surface of said housing, and wherein if an angle which a first line extending along the inner tapered surface makes with a lateral line extending in a transverse direction perpendicular to a length of the gas sensor is defined as φ1°, an angle which a second line extending along the outer tapered surface makes with the lateral line is defined as φ2°, and an angle which the first line makes with the second line is defined as φ3°, they meet relations of 0≦φ1≦50, 0≦φ2≦50, and 120≦φ3≦180 where φ1+φ2+φ3=180°.

125. A gas sensor as set forth in claim 123, wherein said powder seal is made up of a plurality of layers laid overlap each other.

126. A gas sensor as set forth in claim 123, wherein said powder seal is made of a first and a second compressed powder component, the first compressed powder component containing 80 or more parts by weight of particles having a diameter of 80 to 1000 μm per 100 parts by weight of the second compressed powder component.

127. A gas sensor as set forth in claim 125, wherein at least one of the layers of said powder seal is made of a mixture of powders and fillers.

128. A gas sensor as set forth in claim 127, wherein said fillers are made of sodium primary phoshate.

129. A gas sensor as set forth in claim 127, wherein said fillers are contained in an amount of 0.1 to 10 parts per 100 parts by weight of the powders.

130. A gas sensor as set forth in claim 127, wherein the fillers are made of at least one of barium hydroxide, borosilicate glass, aluminosilicate glass, soda-lime silicate glass, lead silicate glass, low-melting borate glass, lime-alumina-glass, and aluminate glass.

131. A gas sensor as set forth in claim 130, wherein the fillers are contained in an amount of 0.5 to 30 parts by weight per 100 parts by weight of the powders.
